(19) United States
(12) Patent Application Publication
(10) Pub. No.: US 2025/0303676 A1
(43) Pub. Date: Oct. 2, 2025

(54) LAMINATE, USE THEREOF, AND METHOD OF MAKING THE SAME

(71) Applicant: Hexion Inc., Columbus, OH (US)

(72) Inventors: Alex Thomas O'NEIL, Mt. View (NZ); Benjamin Christopher MUNRO, Mt. View (NZ); Mark David CLARK, Springfield, OR (US); Robert B. CURRIE, Stafford, TX (US)

(21) Appl. No.: 19/092,124

(22) Filed: Mar. 27, 2025

Related U.S. Application Data
(60) Provisional application No. 63/570,411, filed on Mar. 27, 2024.

(51) Int. Cl. B32B 21/08; B32B 7/12; B32B 21/12; B32B 21/14; B32B 27/20

(52) U.S. Cl. CPC B32B 21/08; B32B 7/12; B32B 21/12; B32B 21/14; B32B 27/20; B32B 2250/03; B32B 2250/05; B32B 2264/10; B32B 2264/303; B32B 2307/3065; B32B 2607/00

(57) ABSTRACT

Provided herein are laminates comprising a wood or wood-based layer, a sacrificial outer layer, and an intumescent layer between the wood or wood-based layer and the sacrificial outer layer. Also provided herein are methods for producing the laminates, methods of using the laminates, and fire-resistant articles comprising the laminates.

### CROSS-REFERENCE TO RELATED APPLICATIONS

This application claims benefit of and priority to U.S. Provisional Application Ser. No. 63/570,411, filed on Mar. 27, 2024, which is incorporated herein by reference in its entirety.

### FIELD

The present disclosure relates generally to the field of fire-retardant materials, and more specifically, to wood-based laminates comprising an intumescent composition. The present disclosure also relates to methods for producing and using the laminates, and fire-resistant articles comprising the laminates.

### BACKGROUND

Fire safety is a major global concern and the subject of many regulations. Fire-resistant engineered wood products have been developed as a passive form of fire prevention/protection, by reducing, limiting or containing flame spread and ignition. An increasing demand for such products is attributed to the increase in medium/high-density housing, larger communal work/entertainment venues, and governmental building codes requiring materials to meet certain standards dependent on occupancy, risk group and building importance level.

One of the strategies to enhance the fire protection of wood is to treat it with flame retardants, the objective being to delay or prevent the ignition and to diminish the effects of combustion. Existing fire-retardant technology can be classified into two categories: (i) coatings that can be sprayed or applied on the surface of the wood product, and (ii) formulations that can be impregnated in the wood cell structures. However, there are certain limitations to these existing coating techniques, for example, external fire-resistant coatings are often highly acidic, lack durability, lack aesthetic appeal, and/or require proper installation along with continual maintenance. On the other hand, impregnation typically produces heaver panels and requires significant infrastructure to manufacture. Some existing impregnation formulations are also known for leaching chemicals which reduces the effectiveness overtime, may pose environmental concerns and/or alter the aesthetic appearance of the wood.

Intumescent compositions can be utilised to protect materials against fire. Intumescent compositions do not cause significant chemical modification of the substrate but expand under the influence of heat to form a multicellular charred layer which acts as an insulating barrier and protective layer. The intumesced char can expand beyond the original thickness of the coating and alter the heat flux to the substrate consequently inhibiting its thermal degradation, ignition, or combustion. Although the use of intumescent compositions as surface coatings is known, their use can be problematic as the coating must be routinely inspected to ensure it has not been removed, or tampered with, and furthermore, the intumescent coating may over time change the appearance of the surface to which it is applied and can make the surface look rough or uneven.

It is against this background that the present laminates, articles and methods have been developed.

### SUMMARY

The present inventors have discovered that wood-based multi-layered laminates which conceal an intumescent layer behind a sacrificial layer, show excellent fire protection properties combined with the ability to have good aesthetic appeal. Unlike traditional intumescent coatings, the present laminates comprise an internal layer behind a sacrificial layer, which allows the wood-based multi-layered laminate to be sold as a finished product instore. Further, unlike traditional external intumescent coatings, the intumescent layer is concealed within the final product during the manufacturing process, meaning no specialised installation or coating maintenance is required. With the intumescent layer found within the product, it is protected from the external environment, meaning durability is maintained for longer with less concern for scratch resistance or weather protection.

Accordingly, in a first aspect, there is provided a fire-resistant laminate comprising:
a wood or wood-based layer;
a sacrificial outer layer; and
an intumescent layer between the wood or wood-based layer and the sacrificial outer layer;
   wherein the intumescent layer comprises an intumescent composition, the intumescent composition comprising:
an expandable graphite compound;
a binder comprising:
   i) a thermoset compound; and
   ii) a thermoplastic compound;
a catalyst; and
a blowing agent, and
   wherein in use the sacrificial outer layer is consumable on contact with fire to expose the intumescent layer.

In some embodiments, the expandable graphite compound has a mean particle size in the range of from 0.5 microns to 1000 microns.

In some embodiments, the intumescent material comprises:
a first expandable graphite compound having a mean particle size in the range of from 50 microns to 250 microns, and
a second expandable graphite compound having a mean particle size in the range of from 150 micron to 350 microns.

In some embodiments, the weight ratio of first expandable graphite compound to second expandable graphite compound is in the range of from 1:5 to 5:1, optionally from 1:4 to 4:1, or optionally about 1.5:3.5.

In some embodiments, the intumescent material comprises:
a first expandable graphite compound having a mean particle size in the range of from 300 microns to 1000 microns, and
a second expandable graphite compound having a mean particle size in the range of from 0.5 micron to 250 microns.

In some embodiments, the weight ratio of first expandable graphite compound to second expandable graphite compound is in the range of from 10:1 to 1:10, optionally from 4:1 to 1:4.

In some embodiments, the expandable graphite compound is present in an amount in the range of from 1 weight percent to 30 weight percent, optionally from 5 weight percent to 25 weight percent, or optionally from 10 weight percent to 20 weight percent, based on the total weight of the intumescent composition.

In some embodiments, the weight ratio of the thermoplastic compound to thermoset compound in the intumescent material is in the range of from 10:1 to 1:3, optionally from 8:1 to 1:3, or optionally from 6:1 to 1:2, or optionally from 5:1 to 1:1.

In some embodiments, the binder is present in an amount in the range of from 10 weight percent to 80 weight percent, optionally from 25 weight percent to 75 weight percent, or optionally from 30 weight percent to 65 weight percent, based on the total weight of the intumescent composition.

In some embodiments, the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, N-methylolacrylamide-vinyl acetate copolymer, and combinations thereof.

In some embodiments, the thermoset compound comprises a phenol formaldehyde polymer and an N-methylolacrylamide-vinyl acetate copolymer.

In some embodiments, the thermoplastic compound is selected from the group consisting of polyvinyl acetate, poly (methyl (meth) acrylate), poly(ethyl (methacrylate), poly (n-butyl (methacrylate), poly(isobutyl (meth) acrylate), poly (tert-butyl (meth) acrylate), poly (2-hydroxyethyl (meth) acrylate), poly (2-hydroxypropyl (methacrylate), poly (2-ethylhexyl (meth) acrylate), styrene acrylate, and combinations thereof.

In some embodiments, the blowing agent is elected from the group consisting of melamine, plant melamine, melafine, urea, butyl urea, alumina trihydrate, dicyandiamide, benzene sulfonyl-hydrazide, azobisisobutyronitrile, 1,1-azobisformamide, 4,4′oxybis (benzenesulfonhydrazide), dinitroisopentamethylene tetraamine, calcium carbonate, titanium hydride, ammonium bicarbonate, sodium bicarbonate, sodium borohydrate, aluminum bicarbonate, potassium bicarbonate, guanidine, iron bicarbonate, sodium dodecyl sulfate, magnesium carbonate, magnesium carbonate hydroxide, ammonium polyphosphate (APP), melamine cyanurate, dimelamine phosphate, melamine pyrophosphate, melamine oxalate, melamine phthalate, and combinations thereof.

In some embodiments, the blowing agent is present in a amount in the range of from 1 weight percent to 20 weight percent, optionally from 1 weight percent to 10 weight percent, or optionally from 1 to 5 weight percent, based on the total weight of the intumescent composition.

In some embodiments, the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, hexamethylenetetramine, hexamine, ammonium polyphosphate, melamine cyanurate, dimelamine phosphate, methanesulfonic acid, and combinations thereof.

In some embodiments, the catalyst is present in an amount in the range of from 0.5 weight percent to 20 weight percent, optionally from 1 weight percent to 10 weight percent, or optionally from 5 weight percent to 10 weight percent, based on the total weight of the intumescent composition.

In some embodiments, the intumescent composition comprises one or more of a dispersant, defoamer, coalescing agent, thickener and pigment.

In some embodiments, the intumescent composition comprises a dispersant, the dispersant comprising a high molecular weight block copolymer with pigment affinic groups and/or a modified styrene maleic acid copolymer.

In some embodiments, the intumescent composition comprises a defoamer, the defoamer comprising an emulsion of paraffin-based mineral oils and hydrophobic particles containing silicon, and/or a modified organopolysiloxane emulsion.

In some embodiments, the intumescent layer comprises a support which carries the intumescent composition.

In some embodiments, the intumescent layer comprises a mesh support which is coated with the intumescent composition.

In some embodiments, the mesh support is formed of activated carbon, graphite, fibreglass, wood, fibre, wire, or a combination thereof.

In some embodiments, the intumescent layer is an intumescent composition which has been applied to the wood or wood-based layer and/or to the sacrificial layer.

In some embodiments, the sacrificial layer and/or the wood or wood-based layer is formed of a material selected from the group consisting of laminated veneer lumber (LVL), low-density fibreboard (LDF), medium-density fibreboard (MDF), high-density fibreboard/hardboard (HDF), plywood, composite wood, marine plywood, multiply plywood, interior plywood, exterior plywood, fire-rated plywood, medium-density overlay plywood, high-density overlay plywood, low-density fibreboard, particle board, oriented strand board (OSB), parallel strand lumber (PSL), optimised engineered lumber (OEL), pine, solid lumber, strawboard, signboard, timber, construction timber, finishing timber, decorative timber, solid wood, hard wood, or a combination thereof.

In some embodiments, the sacrificial layer and/or the wood or wood-based layer is formed of plywood or LVL.

In some embodiments, the sacrificial outer layer has a thickness of up to 10 mm, optionally a thickness of up to 5 mm, or optionally a thickness of up to 3 mm, or optionally a thickness of up to 1 mm, or optionally a thickness of up to 0.5 mm.

In some embodiments, the sacrificial outer layer is a face veneer or decorative

panel.

In some embodiments, one or more of the sacrificial outer layer, intumescent layer and wood or wood-based layer comprises an acoustic hole.

In some embodiments, when the laminate is exposed to fire whilst measuring heat release using a cone calorimeter, following initial peak heat release associated with combustion of the outer sacrificial layer, a secondary peak heat release occurs more 5 minutes, optionally more than 10 minutes, or optionally more than 15 minutes, or optionally more than 20 minutes after the initial peak heat release.

In some embodiments, two or more layers of the laminate are bonded together with an adhesive.

In some embodiments, the intumescent composition comprises an adhesive, thereby enabling the intumescent composition to bond to the wood-or wood-based layer, and to bond to the sacrificial outer layer.

In some embodiments, the intumescent layer comprises a support which carries the intumescent composition, and wherein the intumescent composition comprises an adhesive, thereby enabling the intumescent composition to bond to the support, and to bond the support to bond to the wood-or wood-based layer, and to the sacrificial outer layer.

In some embodiments, the adhesive comprises an amino-formaldehyde resin, a phenolic-formaldehyde resin, a, melamine-urea-formaldehyde resin, a PVA glue, or a combination thereof.

In some embodiments, the average tensile strength required to delaminate two or more of the layers of the laminate is in the range of from 0.38 to 0.50 N/mm, optionally in the range of from 0.40 to 0.48 N/mm, or optionally in the range of from 0.42 to 0.46 N/mm.

In some embodiments, the laminate has:
one outer sacrificial layer;
one wood or wood-based layer; and
one intumescent layer which is disposed between the wood or wood-based layer and the outer sacrificial layer.

In some embodiments, the laminate comprises:
two outer sacrificial layers on opposing faces of the laminate;
a wood or wood-based layer; and
two intumescent layers, one intumescent layer being disposed between the wood or wood-based layer and one outer sacrificial layer, and the other intumescent layer being disposed between the wood or wood-based later and the other outer sacrificial layer.

In some embodiments, the laminate has one or more of the following: a fire rating of Group 1, Group 2, or Group 3 according to AS5637.1 or AS9705, and a fire rating of Group 1-s or Group 2-s according to NZBC.

In a further aspect, there is provided a method of making the fire-resistant laminate of the first aspect, the method comprising the steps of:
coating a support with an intumescent composition as defined above; and
forming a fire-resistant laminate by bonding the coated support with a sacrificial outer layer and with a wood or wood-based layer;

or
coating a wood or wood-based layer with an intumescent composition as defined above to form an intumescent layer; and
forming a fire-resistant laminate by bonding the intumescent layer and wood or wood-based layer to the sacrificial outer layer.

In some embodiments, the method comprises coating a support with an intumescent composition, and wherein the coated support is bonded with a sacrificial outer layer and with a wood or wood-based layer using an adhesive, optionally wherein the adhesive comprises a phenolic-formaldehyde resin, melamine-urea-formaldehyde resin, PVA glue, or a combination thereof.

In some embodiments, the intumescent layer and wood or wood-based layer are bonded with the sacrificial outer layer using an adhesive, optionally wherein the adhesive comprises a phenolic-formaldehyde resin, melamine-urea-formaldehyde resin, PVA glue, or a combination thereof.

In some embodiments, the laminate is cold pressed and/or hot-pressed, optionally using a pressure in the range of from 100 to 500 psi.

In a further aspect, there is provided a fire-resistant article comprising the fire-resistant laminate as defined above.

In some embodiments, the article is a construction material, optionally wherein the article is a door, a wall, building panel, a skirting board, building facade, or an architrave.

In some embodiments, the article is a wall or door.

In a further aspect, there is provided a method of using the fire-resistant laminate as defined above, or the fire-resistant article as defined above, in construction or as a construction article.

### BRIEF DESCRIPTION OF THE DRAWINGS

So that the present disclosure can be better understood, a more particular description of the aspects and embodiments, summarised above, may be had by reference to embodiments, some of which are illustrated in the appended Figures. It is to be noted, however, that the appended Figures illustrate only typical embodiments of this disclosure and are therefore not to be considered limiting of its scope.

FIG. 1a is a pictorial representation of an embodiment of the fire-resistant laminate having an outer sacrificial layer; a wood or wood-based layer; and an intumescent layer which is disposed between the wood or wood-based layer and the outer sacrificial layer.

FIG. 1b is a pictorial representation of a second embodiment of the fire-resistant laminate having two outer sacrificial layers on opposing faces; a wood or wood-based layer; and two intumescent layers, one intumescent layer being disposed between the wood or wood-based layer and one outer sacrificial layer, and the other intumescent layer being disposed between the wood or wood-based later and the other outer sacrificial layer.

FIG. 2 is a photographic image of an embodiment of a mesh support which can be used in the intumescent layer of the laminate, on top of a wood-based layer.

FIG. 3 is a photographic image of a press used to manufacture example laminates.

FIG. 4 is a photographic image of an example of a two-plywood test system comprising a mesh support sandwiched in-between two veneers used to evaluate bond strength.

FIG. 5 is a photographic image of an embodiment of a mesh support coated with intumescent composition, for use as an intumescent layer in a laminate.

FIG. 6 shows photographic images of an embodiment of a laminate in accordance with the present disclosure in which the intumescent layer is a coated mesh support, showing the layers of the laminate in two different views: (a) at a distance, and (b) close-up. FIG. 7a is a photographic image of a wood-based layer coated with an

intumescent composition.

FIG. 7b is a photographic image of an embodiment of a laminate according to the present disclosure having an intumescent layer formed from applying an adhesive intumescent composition to a wood or wood-based layer and applying a sacrificial outer layer.

FIG. 8 shows photographic images of fire-resistance experiments conducted on a laminate comprising a mesh support coated with the intumescent composition as the intumescent layer, conducted by using a blowtorch to exposure the laminate to fire. The experiments show: (a) a laminate at the point at which it is initially exposed to a propane torch; (b) a laminate after 5 minutes of continual blowtorch exposure; (c) a laminate 15 seconds after continual blowtorch exposure is ceased; and (d) a laminate several minutes after continual blowtorch exposure is ceased.

FIG. 9 shows photographic images of fire-resistance experiments conducted on a laminate comprising an intumescent composition layer (no mesh), conducted by using a blowtorch to expose the laminate to fire. The experiments show: (a) a laminate immediately after blowtorch exposure commences; (b): a laminate after 5 minutes of continual blowtorch exposure; and (c): a laminate several minutes after continual blowtorch exposure is ceased. On one side of (c), the intumescent composition remains present. On the other side of (c), the intumescent composition has been removed, exposing the backing plywood, and demonstrating a lack of damage thereto.

FIG. 10 shows photographic images of fire-resistance experiments conducted on a laminate comprising a mesh support coated with the intumescent composition as the intumescent layer, with 8 mm acoustic holes, conducted by using a blowtorch to expose the laminate to firs. The experiments show: (a) a laminate at the point at which it is initially exposed to a blowtorch; and (b) a laminate after 5 minutes of continual blowtorch exposure.

FIG. 11 shows two graphs of time vs rate of heat release (kW/M²) obtained using cone calorimetry experiments conducted on exemplary laminates of the disclosure with an 0.8 mm sacrificial layer. Data is presented for (a) a multilayered laminate comprising a mesh support coated with the intumescent composition as the intumescent layer; and (b) a multilayered laminate comprising the liquid intumescent composition layer (no mesh). These data demonstrate that once the sacrificial layer burns off to give an initial peak heat release, the energy release is reduced to near zero for 20 minutes for the laminate comprising a mesh supported intumescent layer, and to near zero for 10 minutes for the laminate comprising a liquid-based intumescent layer, before further significant heat release is observed.

### DETAILED DESCRIPTION

### Definitions

Unless specifically defined otherwise, all technical and scientific terms used herein shall be taken to have the same meaning as commonly understood by one of ordinary skill in the art.

The present disclosure refers to the entire contents of certain documents being incorporated herein by reference. In the event of any inconsistent teaching between the teaching of the present disclosure and the contents of those documents, the teaching of the present disclosure takes precedence.

It is to be understood that if any prior art publication is referred to herein, such reference does not constitute an admission that the publication forms a part of the common general knowledge in the art.

As used herein, the term “and/or”, e.g., “X and/or Y” shall be understood to mean either “X and Y” or “X or Y” and shall be taken to provide explicit support for both meanings or for either meaning.

For purposes of this present disclosure, and unless otherwise specified, all numerical values within the detailed description and the claims herein which are modified by “about” or “approximately” the indicated value, are in consideration of experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

Throughout this specification, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Unless otherwise indicated, terms such as “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the word “comprise” and other forms of the word, such as “comprising” and “comprises,” are used in an inclusive sense, i.e. to specify the presence of the stated features but not to preclude the presence or addition of further features in various embodiments of the disclosure.

The disclosure also includes all of the steps, features, compositions, layers and components thereof referred to or indicated in this specification, individually or collectively, and any and all combinations or any two or more of said steps or features.

Each embodiment of the present disclosure described herein is to be applied mutatis mutandis to each and every other embodiment unless specifically stated otherwise or required otherwise by context.

### Fire-Resistant Laminate

The present disclosure relates to a fire-resistant laminate which utilises an intumescent composition as a concealed intumescent layer behind a thin face veneer or veneers of a wood-based product, which acts as a sacrificial layer in the event of a fire. When burned off, this allows for the intumescent layer to protect the remaining internal wood or wood-based layer from the fire. It has also been found that intumescent compositions containing an expandable graphite compound, a binder comprising a thermoset compound and a thermoplastic compound, a catalyst and a blowing agent, perform particularly well in the laminates.

Accordingly, in a first aspect, there is provided a fire-resistant laminate comprising:
a wood or wood-based layer;
a sacrificial outer layer; and
an intumescent layer between the wood or wood-based layer and the sacrificial outer layer;
   wherein the intumescent layer comprises an intumescent composition, the intumescent composition comprising:
an expandable graphite compound;
a binder comprising:
   i) a thermoset compound; and
   ii) a thermoplastic compound;
a catalyst; and
a blowing agent, and
   wherein in use the sacrificial outer layer is consumable on contact with fire to expose the intumescent layer.

### Wood or Wood-Based Layer

The fire-resistant laminate comprises a wood or wood-based layer; a sacrificial outer layer; and an intumescent layer between the wood or wood-based layer and the sacrificial outer layer.

The wood or wood-based layer is intended to provide strength to the laminate.

In some embodiments a wood layer is used. In some other embodiments, a wood-based layer is used. A wood-based layer is a layer of material which comprises wood together with other components, for example a fiberboard which contains wood fibers together with adhesive.

The wood or wood-based layer may be formed using any wood or wood-containing material. The wood or wood-based layer may in some embodiments itself be formed of multiple layers, such as in the case of plywood, which is a composite material manufactured from thin layers or plies of wood that are glued together.

In some embodiments, the wood or wood-based layer is selected from the group consisting of laminated veneer lumber (LVL), low-density fibreboard (LDF), medium-density fibreboard (MDF), high-density fibreboard/hardboard (HDF), plywood, composite wood, marine plywood, multiply plywood, interior plywood, exterior plywood, fire-rated plywood, medium-density overlay plywood, high-density overlay plywood, low-density fibreboard, particle board, oriented strand board (OSB), parallel strand lumber (PSL), optimised engineered lumber (OEL), pine, e.g., radiata pine and hoop pine, solid lumber, strawboard, signboard, timber, construction timber, finishing timber, decorative timber, solid wood, hard wood, or a combination thereof.

In some embodiments, the wood or wood-based layer is plywood or LVL. Plywood and LVL are multilayered engineered board materials, fabricated from the layering and gluing of wooden veneers.

There are three categories for plywood commonly used in construction: Floor Materials and Coverings; Wall and Ceiling Linings; and Other materials.

In some embodiments, a single wood or wood-based layer may be used in the laminate. In some other embodiments, multiple wood or wood-based layers may be used in the laminate, for example two, three, four, five or more layers, depending on the specific design of the laminate.

Any suitable shape or size of wood or wood-based layer may be used, depending on the intended application.

In some embodiments, the thickness of the wood or wood-based layer is in the range of from 5 mm to 500 mm, or from 5 mm to 250 mm, or from 5 mm to 200 mm, or from 5 mm to 150 mm, or from 5 mm to 100 mm, or from 5 mm to 75 mm, or from 5 mm to 50 mm, or from 10 mm to 500 mm, or from 10 mm to 250 mm, or from 10 mm to 200 mm, or from 10 mm to 150 mm, or from 10 mm to 100 mm, or from 10 mm to 75 mm, or from 10 mm to 50 mm, or from 20 mm to 500 mm, or from 20 mm to 250 mm, or from 20 mm to 200 mm, or from 20 mm to 150 mm, or from 20 mm to 100 mm, or from 20 mm to 75 mm, or from 20 mm to 50 mm, or from 50 mm to 500 mm, or from 50 mm to 250 mm, or from 50 mm to 200 mm, or from 50 mm to 150 mm, or from 50 mm to 100 mm, or from 100 mm to 500 mm, or from 100 mm to 250 mm.

### Sacrificial Outer Layer

The sacrificial outer layer is, in use, intended to provide an aesthetically pleasing appearance concealing the intumescent layer, whilst protecting the intumescent layer. Preferably, when exposed to fire, the sacrificial layer is rapidly combustible so as to expose the intumescent layer which then expands and provides fire-resistance properties. Preferably, when exposed to fire, the sacrificial layer is combustible so as to expose the intumescent layer without releasing significant energy, i.e. without combusting significant quantities of material which can contribute to the fire growing.

In normal use, the sacrificial outer layer is on the exterior of the laminate and is visible.

A sacrificial outer layer may in some embodiments be provided on only one face of the laminate, for example on one face of a door. In some other embodiments, a sacrificial outer layer may be provided on multiple faces of the laminate, for example where the laminate is in the form of a door it may be provided on opposing major faces of the door.

The sacrificial layer may be formed using any suitable material. For example, it may be formed using a wood or wood-based material.

In some embodiments, the sacrificial outer layer is formed of a material selected from the group consisting of laminated veneer lumber (LVL), low-density fibreboard (LDF), medium-density fibreboard (MDF), high-density fibreboard/hardboard (HDF), plywood, composite wood, marine plywood, multiply plywood, interior plywood, exterior plywood, fire-rated plywood, medium-density overlay plywood, high-density overlay plywood, low-density fibreboard, particle board, oriented strand board (OSB), parallel strand lumber (PSL), optimised engineered lumber (OEL), pine, e.g., radiata pine and hoop pine, solid lumber, strawboard, signboard, timber, construction timber, finishing timber, decorative timber, solid wood, hard wood, or a combination thereof.

In some embodiments, the sacrificial outer layer is made of plywood or LVL.

In some embodiments, the sacrificial outer layer is made of a wood veneer.

In some embodiments, the sacrificial outer layer is made of a pine veneer.

In some embodiments, the sacrificial outer layer is a face veneer or decorative panel. Advantageously, use of a face veneer or decorative panel allows the laminate to possess aesthetic appeal, while still providing the desired fire performance. Furthermore, this feature easily permits incorporation into current manufacturing and does not cause the product to become noticeably heavier, which is ideal for installation or utilisation in fire doors or the like.

In some embodiments, the sacrificial layer and/or the wood or wood-based layer is formed of plywood or LVL.

The sacrificial outer layer may be of any desired width or length, depending on the intended application.

The sacrificial outer layer is readily combustible in the event of exposure to fire. Preferably, the sacrificial outer layer is of low thickness such that combustion of the layer does not result in significant release of energy.

In some embodiments, the sacrificial outer layer, upon combustion, releases less than not more than 100 kW/m² energy over a period of time of not more than 2 minutes.

In some embodiments, the sacrificial outer layer is rapidly combustible. In some embodiments, the sacrificial outer layer is combusted with 3 minutes, or within 2 minutes, or within 1 minute, or within 30 seconds of being set alight.

In some embodiments, the sacrificial outer layer has a thickness of up to 10 mm, or a thickness of up to 5 mm, or a thickness of up to 3 mm, or a thickness of up to 1 mm, or optionally a thickness of up to 0.5 mm.

In some embodiments, the sacrificial outer layer has a thickness in the range of from 0.2 mm to 5 mm, or from 0.3 mm to 3 mm, or from 0.4 mm to 2.5 mm, or from 0.5 mm to 2 mm.

In some embodiments, the sacrificial outer layer has a maximum thickness of 30 mm, or a maximum thickness of 25 mm, or a maximum thickness of 20 mm, or a maximum thickness of 15 mm, or a maximum thickness of 10 mm, or a maximum thickness of 9 mm, or a maximum thickness of 8 mm, or a maximum thickness of 7 mm, or a maximum thickness of 6 mm, or a maximum thickness of 5 mm, or a maximum thickness of 4 mm, or a maximum thickness of 3 mm, or a maximum thickness of 2 mm, or a maximum thickness of 1 mm, or a maximum thickness of 0.8 mm, or a maximum thickness of 0.6 mm, or a maximum thickness of 0.5 mm.

The typical low thickness of the sacrificial veneer allows production of a product which performs well in ISO 9705 room burn testing.

The laminate comprises an intumescent layer comprising an intumescent composition. Intumescent compositions are compositions that, in the event of a fire, expand and swell as a result of heat exposure, thus increasing in volume and decreasing in density. The ability of the intumescent layer to swell and for, a thermally insulating char that delays diffusion of heat to the underlying substrate, can retard penetration of fire through the laminate.

The intumescent composition comprises: an expandable graphite compound; a binder comprising: i) a thermoset compound; and ii) a thermoplastic compound; a catalyst; and a blowing agent.

In some embodiments, the intumescent composition increases in volume by at least 10-fold, or at least 20-fold, or at least 30-fold, or at least 40-fold, on exposure to temperatures of 100° C. or greater.

In some embodiments, the intumescent composition expands to have a density of less than 130 cc/g, or less than 120 cc/g, or less than 110 cc/g, or less than 100 cc/g, following exposure to conditions of 400° C.

In some embodiments, the intumescent layer takes the form of a layer of intumescent composition which has been applied between the wood or wood-based layer and the sacrificial outer layer. For example, the intumescent composition may comprise an adhesive, or have adhesive properties, such that it can be applied to one of the wood or wood-based layer and the sacrificial outer layer, and then brought into contact with the other of the wood or wood-based layer and the sacrificial outer layer, and the layers maintained in proximity until they adhere. Thus, in some embodiments, the intumescent layer is an intumescent composition which has been applied to the wood or wood-based layer and/or to the sacrificial layer.

In some other embodiments, the intumescent layer comprises a support which carries the intumescent composition. For example, the intumescent composition can be applied (e.g. in liquid form) onto a suitable support thereby coating it. Following drying (in the case of liquid application), an intumescent layer is provided.

Any suitable type of support may be used, for example, yarns, tows, whiskers, continuous fibres, short fibres, woven fabrics, woven sheets, knitted fabrics, non-woven fabrics, random mats, needled mats, screens, meshes, felts, braided fabrics, wound tows, wire and/or other forms.

In some embodiments, the intumescent layer comprises a support which is a mesh which is coated with the intumescent composition. Advantageously, the use of a mesh in combination with the intumescent composition can easily be incorporated into normal plywood fabrication processes. Furthermore, with a mesh support, the laminate can maintain its natural veneer appearance.

In some embodiments, the intumescent layer comprises a support which is formed of a material such as activated carbon, graphite, fibreglass, wood, fibre, wire, or a combination thereof. In some embodiments, a mesh support is used which is formed of a material such as activated carbon, graphite, fibreglass, wood, fibre, wire, or a combination thereof.

Examples of suitable fibres include, but are not limited to, nickel fibre, glass fibre, carbon fibre, graphite fibre, mineral fibre, oxidized carbon fibre, oxidized graphite fibre, oxidized polyacrylonitrile fibre, steel fibre, metallic fibre, metal-coated carbon fibre, metal-coated glass fibre, metal-coated graphite fibre, metal-coated ceramic fibre, nickel-coated graphite fibre, nickel-coated carbon fibre, nickel-coated glass fibre, quartz fibre, ceramic fibre, fibreglass, silicon carbide fibre, stainless steel fibre, titanium fibre, nickel alloy fibre, brass-coated steel fibre, polymeric fibre, polymer-coated carbon fibres, polymer-coated graphite fibre, polymer-coated glass fibre, ceramic-coated carbon fibre, ceramic-coated graphite fibre, or combinations thereof.

In some preferred embodiments, where a support carrying the intumescent composition is used, the support is poorly combustible, or is non-combustible. The use of such a support further assists the fire retardant properties of the laminate.

Where a support is used, it may contain additional components. For example, in some embodiments, a support is used which comprises one or more of phosphates, sulfamates, halides and nitrogen-rich molecules. Such additional components are understood to assist in quenching fire by free radical quenching.

In some embodiments where the intumescent layer comprises a support (e.g. a mesh support) coated with the intumescent composition, the intumescent composition comprises a single expandable graphite compound only. For example, the expandable graphite compound may be one having a mean particle size of from 90 to 350 microns, or from 50 microns to 250 microns, or from 150 microns to 350 microns. In some embodiments, the expandable graphite compound has 100-mesh particle size. In some embodiments, the expandable graphite compound is GRAFGUARD® 200-100N.

In some embodiments where the intumescent composition is applied to form an intumescent layer without using a support, the intumescent composition comprises a first expandable graphite compound and a second expandable graphite compound. For example, the first expandable graphite compound may have a mean particle size in the range of from 50 to 250 microns, and the second expandable graphite compound may have a mean particle size in the range of from 90 to 350 microns. In some embodiments, the first expandable graphite compound has 80-mesh particle size, and the second expandable graphite compound has 100-mesh particle size. In some embodiments, the first expandable graphite compound is GRAFGUARD® 160-80N and the second expandable graphite compound is GRAFGUARD® 200-100N.

Depending on the nature of the intumescent composition, in some embodiments where the intumescent composition is sufficiently adhesive without a specific adhesive component being added, the intumescent composition may be used without the need for an adhesive or a binding agent. For example, the intumescent composition can be introduced to other layers in a liquid state and upon the curing or drying of the intumescent composition, the composition adheres to other layers.

In some other embodiments, one or more adhesive components may be added to the intumescent composition, to improve adhesion, e.g. of the composition to a support, and/or of the layers to one another.

In preferred embodiments, where one or more adhesive components are used, the adhesive components do not substantially reduce or impede the intumescent properties of the intumescent layer.

In some embodiments, the adhesive is a polyvinyl acetate, an emulsion polymer isocyanate or an acrylic adhesive.

Advantageously, a liquid system enables the intumescent and adhesive to be combined in a single system. A liquid system can be applied to the substrate by any suitable means known to persons skilled in the art. In some embodiments, the liquid system is applied as a spray, curtain coater, or extruder. In some embodiments, the intumescent composition can be used in combination with other fire-retardant systems.

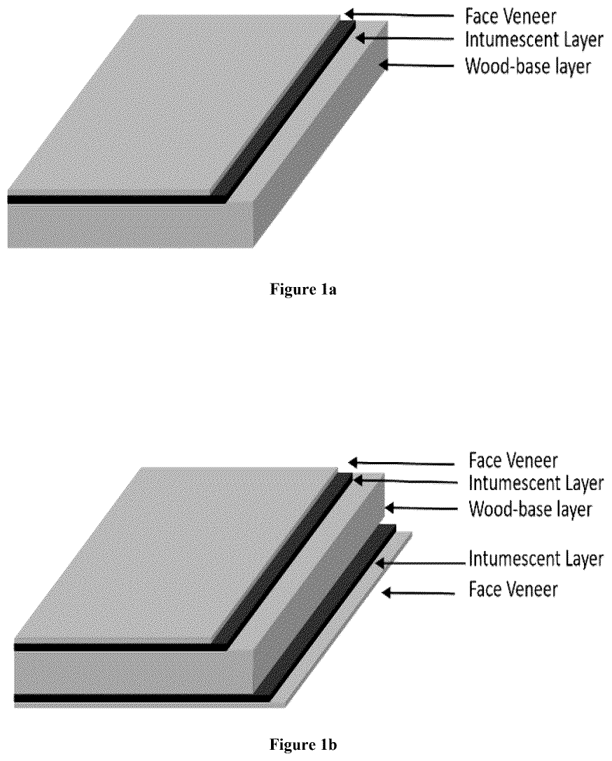

In its simplest form, the laminate may have:
one outer sacrificial layer;
one wood or wood-based layer; and
one intumescent layer which is disposed between the wood or wood-based layer and the outer sacrificial layer. A schematic representation of such a laminate is shown in FIG. 1a.

For example, such a construction may be used where fire protection is only required on one side of the laminate, e.g. in the case where the laminate is in the form of the door, and protection against fire is only required in one direction.

However, other forms of laminate are also contemplated. For example, in some other embodiments, the laminate comprises:
two outer sacrificial layers on opposing faces of the laminate;
a wood or wood-based layer; and
two intumescent layers, one intumescent layer being disposed between the wood or wood-based layer and one outer sacrificial layer, and the other intumescent layer being disposed between the wood or wood-based later and the other outer sacrificial layer.

A schematic representation of such a laminate is shown in FIG. 1b. Such a construction may be of use, for example, in doors where fire retardancy properties are required in both directions.

The multilayered laminate of the present disclosure may be configured in any suitable manner depending on the desired use and required fire performance rating. Accordingly, the multilayered laminate may comprise any number of intumescent layers and wood or wood-based layers. For example, the laminate may comprise from 1, or 2, or 3, or 4, or 5 intumescent layers and/or from 1, or 2, or 3, or 4, or 5 wood or wood-based layers.

In some embodiments, one or more of the sacrificial layers, intumescent layer and/or wood or wood-based layers comprise acoustic holes. Wood-based products perform strongly in the acoustic arena-whether the objective is to enhance sound or reduce sound. A network of small interlocking wood cells converts sound energy into heat energy by frictional resistance within these cells and by vibrations within their sub-structure. Because of this internal friction, wood has a stronger sound dampening capacity than most structural materials. The natural acoustic properties of wood control this excessive echo, or reverberation, by reducing the transmission of sound vibrations, and accordingly, many public buildings, clad walls and ceilings are lined with acoustic timber panels or spaced timber battens. Plywood and wood fibre acoustic products are used in theatres and auditoriums to provide low-frequency reverberation control. Timber acoustic panelling uses holes or slots to increase the amount of sound absorption, essentially breaking up the energy of the soundwave. By breaking up the sound, the echoes are reduced. It is anticipated that multilayered laminate of the present disclosure containing acoustic holes may advantageously be used in settings that require both acoustic performance and fire performance.

### Intumescent Compositions

The intumescent layer comprises an intumescent composition, the intumescent composition comprising: an expandable graphite compound; a binder comprising: i) a thermoset compound; and ii) a thermoplastic compound; a catalyst; and a blowing agent.

### Expandable Graphite Compounds

The intumescent composition used in the laminate of the present disclosure comprises an expandable graphite compounds. In some embodiments, the intumescent composition contains a single type of expandable graphite compound. In some other embodiments, the intumescent composition contains multiple types of expandable graphite compound, for example two, three, four or five types of expandable graphite compound. In some embodiments, the intumescent composition comprises a first expandable graphite compound and a second expandable graphite compound.

Expandable graphite is a synthesised intercalation compound of graphite that expands when heated. Expandable graphite may for example be formed by treating crystalline graphite, which is composed of stacks of parallel planes of carbon atoms, with intercalants such as sulfuric acid and nitric acid. Since no covalent bonding exists between the planes of the carbon atoms, the intercalant can be inserted between them. This allows the intercalant to be positioned within the graphite lattice. When the intercalated graphite is exposed to heat or flame, inserted molecules can decompose and release gases. The graphite layer planes are pushed apart by the gas and the graphite expands many times beyond its original thickness (for example up to 50×, up to 100×, up to 150×, up to 200×, up to 250× or up to 300× the original thickness), its bulk density is lowered, and its surface area is increased. This results in a low-density thermal insulation layer. Expandable graphite can also be referred to as expandable flake graphite, intumescent flake graphite, or expandable flake.

Compositions containing expandable graphite compounds have been found to be particularly effective in the laminates of the present disclosure.

The expandable graphite compound can be used in any suitable amount to provide the desired fire performance properties required by the laminate. For example, the expandable graphite compound, may be present in the intumescent composition in the range of from 1 weight percent to 50 weight percent, based on the total weight of the composition. Any and all ranges between 1 weight percent and 50 weight percent are included herein and disclosed herein; for example, in some embodiments, the expandable graphite can be present in the intumescent composition in the range of from 1 weight percent to 40 weight percent, or 1 weight percent to 35 weight percent, or 1 weight percent to 30 weight percent, or 5 weight percent to 30 weight percent, or 5 weight percent to 25 weight percent, or 10 weight percent to 20 weight percent, based on the total weight of the intumescent composition.

In some embodiments, the expandable graphite compound is present in an amount in the range of from 1 weight percent to 30 weight percent, optionally from 5 weight percent to 25 weight percent, or optionally from 10 weight percent to 20 weight percent, based on the total weight of the intumescent composition.

The expandable graphite compound can be characterised by a mean particle size. Mean particle size may be determined using any suitable technique, for example by sieve analysis involving passing a sample through a series of mesh screens with different size openings, by laser diffraction, by dynamic light scattering, or by direct microscopy.

In some embodiments, the expandable graphite compounds have a mean particle size in the range of from 0.5 microns to 1000 microns, or from 50 microns to 500 microns, or from 50 microns to 250 microns, or from 75 microns to 225 microns, or from 100 microns to 200 microns, or from 125 microns to 175 microns, or about 150 microns.

In some embodiments, the mean particle size of the expandable graphite compound is in the range of from 150 microns to 350 microns, or from 125 microns to 325 microns, from 100 microns to 300 microns, or from 125 microns to 275 microns, or about 250 microns.

In some embodiments, the mean particle size of the expandable graphite compound is in the range of from 300 microns to 950 microns, or from 375 microns to 950 microns, or from 400 microns to 800 microns, or from 450 microns to 600 microns.

In some embodiments, the mean particle size of the expandable graphite compounds is in the range of from 1 micron to 200 microns, or from 20 microns to 200 microns, or from 40 microns to 175 microns, or from 75 microns to 150 microns.

In some embodiments, at least 50%, or at least 75%, or at least 90%, of the particles in the expanded graphite compound have a particle size of less than 750 microns.

In some embodiments, at least 50%, or at least 75%, or at least 90%, of the particles in the expanded graphite compound have a particle size of less than 250 microns

In some embodiments, the expandable graphite compound contains no halogenated fire-retardant additive.

Commercially available examples of expandable graphite include, but are not limited to Nyagraph® 35, Nyagraph® 251, Nyagraph® 351 (Nyacol® Nano Technologies, Inc., Ashland, MA), Grafguard® 160-80N and Grafguard® 200-100N (Graf Tech International, Brooklyn Heights, OH).

Typically, expandable graphite is available in a variety of particle size distributions. This varies with the manufacturer and grade. For example, Nyagraph® 251 has a particle distribution of the following: below 150 microns-1-5%, 150 microns-300 microns: 9-15%, 300 microns-710 microns: 79-85%, and over 710 microns: 1-5%. Grafguard® 160-80N and Grafguard® 200-100N also have a wide particle size distribution.

In some embodiments, the expandable graphite compound is selected from the group consisting of Nyagraph® 35, Nyagraph® 251, Nyagraph® 351 (Nyacol® Nano Technologies, Inc., Ashland, MA), Grafguard® 160-80N and Grafguard® 200-100N (Graf Tech International, Brooklyn Heights, OH).

In some embodiments, the expandable graphite compound is selected from the group consisting of Grafguard® 160-80N and Grafguard® 200-100N (Graf Tech International, Brooklyn Heights, OH).

GrafGuard® expandable graphite flake is a specifically engineered intumescent material used as a fire-retardant additive. Upon exposure to high temperatures, the material expands and forms a graphite char that is more resistant to degradation than the carbon chars formed from typical chemical intumescent materials. GrafGuard® materials contain no halogenated fire-retardant additives and are manufactured without the lead or chromium that can be found in some other expandable graphite flakes.

Furthermore, Grafguard® may expand up to eight times more than competitive products, exhibiting superior performance even at low temperatures. This high expansion makes it possible to reduce loading levels and improve performance. As the amount of additive is reduced, the probability that the physical properties of the final product will be negatively affected is also reduced. Before expansion, Grafguard® expandable graphite has a typical tap density between 0.69 to 0.85 g/cm³. Where conventional flame retardants can lose effectiveness when subjected to heat, humidity or UV radiation, Grafguard® products remain stable indefinitely and provide reliable, consistent and dependable expansion. Advantageously, the surface chemistry of GrafGuard® expandable graphite can be modified to meet specific processing or formulation requirements.

In some embodiments, the expandable graphite compound is selected from the group consisting of Nyagraph® 35 and Nyagraph® 251 351 (Nyacol® Nano Technologies, Inc., Ashland, MA).

In some embodiments, the intumescent compositions comprises a single expandable graphite compound, which is Grafguard® 200-100N (Graf Tech International, Brooklyn Heights, OH).

As discussed above, in some embodiments, the intumescent composition comprises a first expandable graphite compound and a second expandable graphite compound. Typically the first and second expandable graphite compounds have different mean particle size.

In some embodiments, the intumescent composition comprises: a first expandable graphite compound having a mean particle size in the range of from 50 microns to 250 microns, or in the range of from 75 microns to 225 microns, or in the range of from 100 microns to 200 microns, or in the range of from 125 microns to 175 microns, or about 150 microns, and a second expandable graphite having a mean particle size of in the range of from 150 microns to 350 microns, or in the range of from 125 microns to 325 microns, or in the range of from 100 microns to 300 microns, or in the range of from 125 microns to 275 microns, or about 250 microns.

In some embodiments, the intumescent material comprises:
a first expandable graphite compound having a mean particle size in the range of from 50 microns to 250 microns, and
a second expandable graphite compound having a mean particle size in the range of from 150 micron to 350 microns.

Where a first and a second expandable graphite compound is used together, the weight ratio of two components be used in any suitable weight ratio relative to one another to provide the desired fire performance properties required by the laminate. In some embodiments where first and second expandable graphite compounds are used together, the weight ratio of first expandable graphite compound to second expandable graphite compound is in the range of from 1:5 to 5:1, or from 1:4 to 4:1, or about 1.5:3.5.

In some other embodiments, the intumescent composition comprises: a first expandable graphite compound having a mean particle size in the range of from 300 microns to 950 microns, or in the range of from 375 microns to 950 microns, or in the range of from 400 microns to 800 microns, or in the range of from 450 microns to 600 microns, and a second expandable graphite having a mean particle size in the range of from 1 micron to 200 microns, or in the range of from 20 microns to 200 microns, or in the range of from 40 microns to 175 microns, or in the range of from 75 microns to 150 microns.

In some embodiments, the intumescent material comprises:
a first expandable graphite compound having a mean particle size in the range of from 300 microns to 1000 microns, and
a second expandable graphite compound having a mean particle size in the range of from 0.5 micron to 250 microns.

In some embodiments where first and second expandable graphite compounds are used together, the weight ratio of first expandable graphite compound to second expandable graphite compound can be in the range of from 10:1 to 1:10 or from 4:1 to 1:4.

In some embodiments, the intumescent composition comprises Grafguard® 160-80N and Grafguard® 200-100N (Graf Tech International, Brooklyn Heights, OH).

In some other embodiments, the intumescent composition comprises Nyagraph® 35 and Nyagraph® 251 351 (Nyacol® Nano Technologies, Inc., Ashland, MA).

### Binder

The intumescent composition comprises a binder. The binder comprises a thermoplastic compound and a thermoset compound.

One or more thermoplastic compounds may be used. The thermoplastic compound may for example be present as a dispersion. The dispersion can be prepared by any suitable method known to those skilled in the art. In various embodiments, the dispersion is prepared via an emulsion.

Suitable examples of thermoplastic compounds that may find use in the intumescent composition include, but are not limited to, polyvinyl acetate, poly (methyl (meth) acrylate), poly(ethyl (methacrylate), poly (n-butyl (methacrylate), poly (isobutyl (meth) acrylate), poly (tert-butyl (meth) acrylate), poly (2-hydroxyethyl (meth) acrylate), poly (2-hydroxypropyl (methacrylate), poly (2-ethylhexyl (meth) acrylate), styrene acrylic, and combinations thereof.

In some embodiments, the thermoplastic compound is a polyvinyl acetate. In some embodiments, the thermoplastic compound is Multibond 1P2: a crosslinking polyvinyl acetate supplied by Franklin Adhesives and Polymers. In some embodiments, the thermoplastic compound is a styrene acrylic polymer. In some embodiments, the thermoplastic compound is COVINAX FR-A 707, which is an acrylic acid-butyl acrylate styrene polymer supplied by Franklin Adhesives and Polymers.

One or more thermoset compounds may be used. The one or more thermoset compounds are optionally present in the composition as a dispersion. The thermoset dispersion can be prepared by any suitable method known to those skilled in the art. Suitable examples of thermoset compounds include, but are not limited to, phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, N-methylolacrylamide-vinyl acetate copolymer, and combinations thereof.

In some embodiments, the one or more thermoset compounds comprises a phenol formaldehyde polymer and an N-methylolacrylamide-vinyl acetate copolymer.

The binder comprising a thermoplastic compound and a thermoset compound generally has a thermoplastic compound to thermoset compound weight ratio in the range of from 10:1 to 1:3. Any and all weight ratios between 10:1 and 1:3 are included herein and disclosed herein; for example, the binder can have a thermoplastic compound to thermoset compound weight ratio in the range of from 10:1 to 1:3, or from 8:1 to 1:3, or from 8:1 to 1:2.5, from 6.5:1 to 1:2, or from 6:1 to 1:2, from 6:1 to 1:1.5, or from 5:1 to 1:1.

The binder may be present in the intumescent composition in any suitable weight amount to provide the desired fire performance properties required by the laminate. The binder is generally present in the composition in the range of from 10 weight percent to 80 weight percent. Any and all weight percent ranges from 10 weight percent to 80 weight percent are included herein and disclosed herein; for example, the binder can be present in the composition in the range of from 25 weight percent to 70 weight percent, or from 30 weight percent to 65 weight percent, or from 35 weight percent to 60 weight percent.

### Blowing Agent

The intumescent composition also contains a blowing agent. The blowing agent is useful for expanding the binder to increase the thickness of the composition. The blowing agent can also dilute the concentrations of combustible gasses that are released when a wood substrate burns.

Examples of suitable blowing agents that can be used include, but are not limited to, melamine, plant melamine, melafine, urea, butyl urea, alumina trihydrate, dicyandiamide, benzene sulfonyl-hydrazide, azobisisobutyronitrile, 1,1-azobisformamide, 4,4′oxybis (benzenesulfonhydrazide), dinitroisopentamethylene tetraamine, calcium carbonate, titanium hydride, ammonium bicarbonate, sodium bicarbonate, sodium borohydrate, aluminum bicarbonate, potassium bicarbonate, guanidine, iron bicarbonate, sodium dodecyl sulfate, magnesium carbonate, magnesium carbonate hydroxide, ammonium polyphosphate (APP), melamine cyanurate, dimelamine phosphate, melamine pyrophosphate, melamine oxalate, melamine phthalate and combinations thereof. Ammonium polyphosphate (APP) and melamine cyanurate act as an acid source and blowing agent at the same time. In some embodiments, the melamine used can be Melafine® by OCI Nitrogen.

The blowing agent may be present in the intumescent composition in any suitable weight amount, based on the total weight of the composition, to provide the desired fire performance properties required by the laminate. The blowing agent is generally present in the intumescent composition in the range of from 1 weight percent to 30 weight percent, based on the total weight of the composition. Any and all ranges between 1 weight percent and 30 weight percent are included herein and disclosed herein; for example, in some embodiments, the blowing agent can be present in the intumescent composition in the range of from 1 weight percent to 20 weight percent, or in the range of from 1 weight percent to 15 weight percent, or in the range of from 1 weight percent to 10 weight percent, or in the range of from 3 weight percent to 8 weight percent.

### Catalyst

Catalysts are useful in the intumescent composition and assist with the intumescent expansion of the intumescent layer. Any suitable catalyst may be used. Catalyst examples include, but are not limited to, perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, hexamethylenetetramine, hexamine, ammonium polyphosphate, melamine cyanurate, dimelamine phosphate, methanesulfonic acid and combinations thereof. In some embodiments, the catalyst is Exolit AP 422: a fine-particle ammonium polyphosphate, supplied by Clariant.

The catalyst may be present in the intumescent composition in any suitable weight amount, based on the total weight of the composition, to provide the desired fire performance properties required by the laminate. The catalyst is generally present in the intumescent composition in the range of from 1 weight percent to 20 weight percent, based on the total weight of the composition. Any and all ranges between 1 weight percent and 20 weight percent are included herein and disclosed herein; for example, in some embodiments, the catalyst can be present in the intumescent composition in the range of from 1 weight percent to 15 weight percent, or in the range of from 1 weight percent to 10 weight percent, or in the range of from 5 weight percent to 10 weight percent.

### Further Components

The intumescent composition can also contain a variety of optional components. Such optional components include, but are not limited to, toxic gas absorbing materials, absorbent promoters, wetting agents, nucleating agents, accelerators, fillers, buffers, reinforcing additives, surfactants, coalescing agents, pigments, defoamers, dispersants and thickeners. In some embodiments, the intumescent composition comprises one or more of a dispersant, defoamer, coalescing agent, thickener, and pigment.

The dispersant my in some embodiments assist in proper manufacture of the formulation. Proper dispersion of the powder ingredients improves fire performance. Any suitable dispersant may be used in the present disclosure. In some embodiments, the dispersant comprises a high molecular weight block copolymer with pigment affinic groups and/or a modified styrene maleic acid copolymer. Examples of dispersants suitable for use in the present disclosure include, but are not limited to DISPERBYK-190, which is a dispersing additive for aqueous coating systems, supplied by BYK Additives & Instruments.

Typically, defoamers are inert chemicals, which are comprised of a liquid, such as mineral oil or silicone, and a hydrophobic solid, such as hydrophobic silica, ethylene-bis-stearamide, fatty acid, and/or fatty alcohol. Advantageously, the defoamer prevents foaming during mixing and the formation of microbubbles which persist through application creating voids in the coalescing film which, if present, reduce the effectiveness of the fire performance. The defoamer also assists in eliminating foam caused by mixing, grinding, and chemical reactions involved in producing the intumescent composition. Any suitable defoamer may be used in the present disclosure. In some embodiments, the defoamer comprises an emulsion of paraffin based mineral oils and hydrophobic particles, containing silicon, and/or a modified organopolysiloxane emulsion. Examples of dispersants suitable for use in the present disclosure include, but are not limited to BYK-037, which is a volatiles-free, silicone-containing defoamer based on mineral oil, supplied by BYK Additives & Instruments, and Foam-A-Tac 402, supplied by ESP Enterprises.

Any suitable coalescing agent may be used in the present laminates. Advantageously, coalescing agents play an important role in optimising film formation to ensure a uniform and smooth surface finish. Examples of coalescing agents suitable for use in the present laminates include, but are not limited to, ester alcohols, such as 2,2,4-trimethylpentane-1,3-diol monoisobutyrate or isomeric mixture thereof (NX 795/Texanol). Ester alcohols like 2,2,4-trimethylpentane-1,3-diol monoisobutyrate are an effective coalescing agent for latex formulations such as acrylic dispersions, styrene acrylics and vinyl acetate copolymer dispersions, and effectively reduce the minimum film-formation temperature (MFFT) and provides further benefits in end-product properties including increased film integrity, reduced film porosity and less cracking.

Where used, any suitable filler may be used in the present laminates. Exemplary fillers include, but are not limited to, kaolin, meta kaolin, montmorillonites, mica as well as other smectites and other clay or mineral fillers. Optional oxide fillers that could be employed include oxides of boron, aluminum, silicon, zinc, gallium, titanium, zirconium, manganese, iron, molybdenum, tungsten, bismuth, lead, lanthanum, cerium, neodymium, yttrium, calcium, magnesium and barium. Other suitable fillers may include hollow spheres, conductive fillers, friction and/or thermal additives, which can be incorporated to modify physical properties including, but not limited to, density, conductivity, coefficient of friction, or thermal performance. The intumescent composition used in the present laminates readily can be formulated to incorporate a wide variety of the generally above noted fillers to tailor the material performance to suit the specific application. Given these features, the present invention is advantageously suited for many applications, including as fire doors and structures in high temperature environments.

The intumescent composition forms an intumescent layer between the wood or wood-based layer and a sacrificial outer layer.

In some embodiments, two or more layers of the laminate are bonded together with adhesive.

It is important that the layers of the laminate are strongly adhered to one another, so as to provide the appropriate strength to withstand conditions of high temperature and exposure to fire.

As discussed above, depending on the nature of the intumescent composition, it may have sufficient adhesive properties to adhere to and to bond other layers, and/or to bond to a support if a support is used. However. if desired, a suitable adhesive may be used in addition to or as part of the intumescent composition.

In some embodiments, two or more layers of the laminate are bonded together with an adhesive.

In some embodiments, where the laminate comprises a support (e.g. a mesh support) coated with intumescent composition, an adhesive is used to bond the coated support to the wood or wood-based layer and to the sacrificial outer layer.

In some embodiments, the intumescent layer (e.g., support, liquid or spray) is adhered between the internal wood or wood-based layer and a sacrificial layer by an adhesive.

In some embodiments, the intumescent composition comprises an adhesive, thereby enabling the intumescent composition to bond to the wood-or wood-based layer, and to bond to the sacrificial outer layer.

In some embodiments, the adhesive comprises an amino-formaldehyde resin, a phenolic-formaldehyde resin, a, melamine-urea-formaldehyde resin, a PVA glue, or a combination thereof.

In some embodiments, the adhesive is a resin system. Any suitable resin system may be used. In some embodiments, the resin system is an amino-formaldehyde (UF, MF, MUF, MMF) or phenolic-formaldehyde (including resorcinol based) resin.

In some embodiments where the laminate comprises a support (e.g. a mesh support) coated with intumescent composition, an adhesive comprising a phenolic-formaldehyde resin, melamine-urea-formaldehyde resin, PVA glue, or a combination thereof is used.

In some embodiments, where the laminate comprises a support (e.g. a mesh support) coated with intumescent composition, a melamine-urea-formaldehyde (MUF) resin adhesive is used to bond the coated support to the wood or wood-based layer and to the sacrificial outer layer.

In some embodiments where no support is used, the intumescent composition comprises an MUF resin adhesive, to bond the intumescent compositions to the wood-or wood-based layer, and to bond to the sacrificial outer layer.

In some embodiments, an adhesive is used which comprises an additive, such as a filler. Fillers may be incorporated into wood adhesives to lower costs, give body to liquid adhesives and/or to reduce undesired flow or overpenetration into wood. Fillers include neutral or weakly alkaline compounds that typically require no chemical reaction with curing agent, or other components.

Fillers may for example be mixed with other components prior to the application of resin. Fillers can be either organic (e.g., rye, wheat, walnut shell, and wood flours), or inorganic (e.g., calcium carbonate, calcium sulfate, aluminum oxide, or bentonites). In some embodiments, the filler is selected from the group consisting of wheat flour, j-filler, modal flour, corn cob residue, walnut flour, starch (tapioca), mineral-based fillers, and combinations thereof.

As discussed above, it is important that the layers of the multilayered laminate are strongly adhered to one another, so as to provide the appropriate strength to withstand conditions of high temperature and exposure to fire. An appropriate measure of bond strength, i.e., adhesion of the layers to one another, is by analysing the tensile strength. Tensile strength can be defined as the maximum stress that a material can bear before breaking when it is allowed to be stretched or pulled. Advantageously, in some embodiments, the laminate of the present disclosure displays a bond strength between the intumescent layer and the veneers as good or better than PVA wood glue achieves without the mesh present. “Bond” strength is measured by pulling apart or delaminating a layered “sandwich” system of veneer-mesh-veneer and measuring the tensile strength required to break/separate those layers. The inventors have shown that, for example laminates, the intumescent layer with or without a support achieves an enhanced “bond” in terms of stronger tensile strength than PVA wood glue achieves.

In some embodiments, the average tensile strength required to break two or more of the layers of the laminate apart is in the from 0.38 to 0.5 N/mm, or in the range of from 0.4 to 0.48 N/mm, or in the range of from 0.42 to 0.46 N/mm.

Advantageously, the laminate of the present disclosure provides strong fire-resistant performance after the sacrificial layer is exposed to and is consumed by fire. This can be evaluated by a number of methods. For example, bench scale testing using a cone calorimeter may be utilised. A cone calorimeter is an oxygen consumption calorimetry test used to mimic real-world fire scenarios and for predicting real-time fire behaviour in a bench scale setting by converting the oxygen consumption rates into heat release rates. This is an important parameter in fire modelling and can dictate the safety aspects of a flammable release or incidents such as thermal runaway reactions.

In some embodiments, when the laminate is exposed to fire whilst measuring heat release using a cone calorimeter, following initial peak heat release associated with combustion of the outer sacrificial layer, a secondary peak heat release occurs more 5 minutes, or more than 6 minutes, or more than 7 minutes, or more than 8 minutes, or more than 9 minutes, or more than 10 minutes, or more than 11 minutes, or more than 12 minutes, or more than 13 minutes, or more than 14 minutes, or more than 15 minutes, or more than 16 minutes, or more than 17 minutes, or more than 18 minutes, or more than 19 minutes, or more than 20 minutes, after the initial peak heat release.

Fire properties of building products are regulated to minimise rapid fire spread and smoke growth in buildings and ensure safe and timely evacuation of occupants. Group numbers, also called Fire Group numbers or Material Group numbers, are a requirement of the BCA/NCC 2022, for all internal linings of commercial buildings in Australia. In New Zealand, Group Numbers are required for surface finishes in certain areas of some buildings. Often referred to as a fire rating, group numbers are a numeric representation of the reaction-to-fire of a surface finish using a scale rating. They represent how quickly a fire will spread across the surface. Advantageously, in some embodiments the laminate of the present disclosure may possess one or more fire ratings which meet or exceed Australian and/or New Zealand standards.

Accordingly, in some embodiments, the laminate has one or more of the following: a fire rating of Group 1, Group 2, or Group 3 according to AS5637.1 or AS9705.

In some embodiments, the laminate has one or more of the following: a fire rating of Group 1-s or Group 2-s according to NZBC.

### Method of Making the Multilayer Fire-Resistant Laminate

The present disclosure also relates to methods for producing the multi-layered laminate. Thus, in a second aspect, there is provided a method of making the multilayer fire-resistant laminate according to the first aspect, the method comprising the steps of:
coating a support with an intumescent composition as defined above; and
forming a fire-resistant laminate by bonding the coated support with a sacrificial outer layer and with a wood or wood-based layer;

or
coating a wood or wood-based layer with an intumescent composition as defined above to form an intumescent layer; and
forming a fire-resistant laminate by bonding the intumescent layer and wood or wood-based layer to the sacrificial outer layer.

Where the intumescent composition requires preparation, to prepare the prepare the intumescent composition, one or more expandable graphite compounds, catalyst, blowing agent, one or more thermoplastic compounds, and one or more thermoset compounds are mixed together in any order, combination, or sub-combination. Optional components can also be added to the mixture.

In some embodiments, the method comprises coating a support with an intumescent composition as defined above; and forming a fire-resistant laminate by bonding the coated support with a sacrificial outer layer and with a wood or wood-based layer.

In some embodiments, the coated support is bonded with a sacrificial outer layer and with a wood or wood-based layer using an adhesive. Any suitable adhesive may be used of which are known to persons skilled in the art. Examples of suitable adhesives are discussed above in relation to the laminate. In some embodiments, the adhesive used in the method comprises a phenolic-formaldehyde resin, melamine-urea-formaldehyde resin, PVA glue, resorcinol, urea-formaldehyde or derivatives thereof, or a combination thereof. In some embodiments, a melamine-urea-formaldehyde resin is used.

In some embodiments, the method comprises coating a wood or wood-based layer with an intumescent composition as defined above to form an intumescent layer; and forming a fire-resistant laminate by bonding the intumescent layer and wood or wood-based layer to the sacrificial outer layer.

In some embodiments, the intumescent composition has properties sufficient to adhere to the wood or wood-based layer and to the sacrificial outer layer.

In some embodiments, an adhesive is added to aid bonding of the laminate.

Examples of suitable adhesives are discussed above in relation to the laminates. In some embodiments, a melamine-urea-formaldehyde resin is used.

The layers of the laminate may be formed by any suitable methods known to persons skilled in the art, for example by cold-pressing or hot-pressing. In some embodiments, the laminate is formed by cold pressing. In some embodiments, the laminate is formed by hot-pressing. In some embodiments, the laminate is formed by cold pressing followed by hot pressing or vice versa.

Cold pressing may for example be carried out at ambient temperature.

Hot-pressing may be conducted at any suitable temperature. In some embodiments, the hot-pressing is conducted at a temperature in the range of from 30° C. to 300° C., or from 30° C. to 250° C., or from 50° C. to 200° C., from 100° C. to 200° C., or from 125° C. to 175° C., or about 150° C. In some embodiments, hot-pressing is conducted at a temperature in the range of from 70° C. to 110° C., or from 80° C. to 100° C., or about 90° C.

The cold and/or hot-pressing may be conducted for any suitable duration of time. In some embodiments, the cold and/or hot-pressing is conducted in the range of from 1 minute to 15 minutes, or 1 minute to 10 minutes, or 1 minute to 9 minutes, or 1 minute to 8 minutes, or 1 minute to 7 minutes, or 1 minute to 6 minutes, or about 5 minutes.

The cold and/or hot-pressing may be conducted at any suitable pressure. In some embodiments, the cold and/or hot-pressing is conducted at a pressure in the range of from 10 to 2000 psi. In some embodiments, the cold and/or hot-pressing is conducted at a pressure in the range of from 10 to 1500 psi, or in the range of from 10 to 1400 psi, or in the range of from 10 to 1300 psi, or in the range of from 25 to 1200 psi, or in the range of from 25 to 1000 psi, or in the range of from 50 to 1000 psi, or in the range of from 50 to 1000 psi, or in the range of from 50 to 750 psi, or in the range of from 100 to 500 psi, or in the range of from 200 to 400 psi.

### Fire-Resistant Articles Comprising the Fire-Resistant Laminate

The present disclosure also relates to fire-resistant articles comprising the laminate of the first aspect. “Fire resistance” means the ability of a building component to resist a fire, while still performing its function. Accordingly, in a further aspect, there is provided a fire-resistant article comprising the multilayer fire-resistant laminate according to the first aspect. The fire-resistant article of the present disclosure may find use in any desired application which requires fire-protection, such as in residential, commercial, and public buildings (schools, hospitals, offices, etc.), vehicles, ships and carriages, where fire-retardant materials are required.

The article may take any desired form. For example, in some embodiments, the article is a construction material, for example a door, a wall, wall material, building panel, a skirting board, building facade, or an architrave. In some embodiments, the article is a wall, wall material, building panel or door.

### Methods of Using the Fire-Resistant Laminate

The present disclosure also relates to methods for using the fire-resistant laminate or fire-resistant article.

Fire safety is a vital aspect of construction buildings, and using fire-resistant materials plays a crucial role in safeguarding the lives of occupants and the property. Fire-resistant materials are designed to withstand intense heat and resist burning in fire emergencies, thereby preventing, or delaying the spread of flames and reducing their potential loss and damage. Fire-resistant materials play a significant role in multiple aspects of building construction. Firstly, they assist in preventing and containing fires by impeding the spread of flames in a fire and limiting the emission of smoke and toxic gases. Meanwhile, they contribute to the structural integrity, avoiding the collapse of buildings during fire. Additionally, they minimise the loss and damage of property, reducing the potential financial burden and psychological impacts of the fire accident. Moreover, they provide additional escape time to occupants, enhancing occupants' safety and reducing fatalities.

Advantageously, the multilayer fire-resistant laminate of the present disclosure finds use in construction or as a construction article. Accordingly, there is provided a method of using the fire-resistant laminate or the fire-resistant article as described above in construction or as a construction article.

Those skilled in the art will appreciate that the disclosure herein is susceptible to variations and modifications other than those specifically described. It is to be understood that the disclosure includes all such variations and modifications.

### EXAMPLES

The present disclosure is further illustrated by the following non-limiting examples.

### Example 1—Preparation of Intumescent Compositions

Exemplary formulation for intumescent composition used with mesh support.

TABLE 1

| | |
|---|---|
| | Parts Per |
| Ingredient | Hundred |

Part I

| | | |
|---|---|---|
| Dispersant | Polyether-modified styrene- | 0.795 |
| | maleic anhydride copolymer | |
| | (DISPERBYK-190) | |
| Catalyst | Ammonium polyphosphate | 7.712 |
| | (Exolit AP 422) | |
| Blowing agent | Melamine | 3.865 |
| Expandable graphite | Expandable graphite (100 | 15.442 |
| | mesh) (GRAFGUARD ® 200- | |
| | 100N) | |
| Defoamer | Emulsion of paraffinic | 0.199 |
| | mineral oils and hydrophobic | |
| | components (BYK037) | |
| Pigment | Calcium Carbonate | 7.712 |

Part II

| | | |
|---|---|---|
| Water | Water | 14.446 |
| Binders | Latex Resin (COVINAX FR- | 37.927 |
| | A 707) | |
| | Phenolic Resin (XB-91MO) | 9.482 |
| Coalescing agent | 2,2,4-Trimethyl-1,3- | 1.427 |
| | pentanediol monoisobutyrate | |
| | (Texanol) | |
| Thickener | Acrylic self-associative | 0.993 |
| | thickener (Thixol) | |

| | |
|---|---|
| TOTAL | 100.000 |

### Preparation of Exemplary Intumescent Composition Formulation According to Table 1.

The materials from Part I were charged to a vessel while mixing. The mixture was covered with plastic or wax paper and was allowed to stand for one hour for the mixture to reach equilibrium. The mixture was then gently mixed to form a suspension. The suspension was then ground using a Dispermat at 3500 rpm for 20 minutes. After the grinding was completed, the materials from Part II were then charged to the vessel while mixing. The pH and viscosity were then measured. If necessary, the pH was adjusted to above 8.5. The mixture was then thickened with Rheotech 3800 rheology improver to achieve the desired thickness.

Exemplary formulation for liquid intumescent composition (no support).

TABLE 2

| | |
|---|---|
| | Parts Per |
| Ingredient | Hundred |

Part I

| | | |
|---|---|---|
| Dispersant | Polyether-modified styrene- | 0.77 |
| | maleic anhydride | |
| | copolymerDISPERBYK-190 | |
| Defoamer | Modified organopolysiloxane | 0.19 |
| | emulsionFoam-A-Tac 402 | |
| Blowing agent | Melamine | 3.46 |
| Expandable graphite | Expandable graphite (80 | 10.43 |
| | mesh) (GRAFGUARD ® 160- | |
| | 80N) | |
| | Expandable graphite (100 | 4.47 |
| | mesh) (GRAFGUARD ® 200- | |
| | 100N) | |
| Pigment | Calcium carbonate | 7.55 |
| Catalyst | Ammonium polyphosphate | 6.92 |
| | (Exolit AP 422) | |

Part II

| | | |
|---|---|---|
| Water | Water | 10.31 |
| Binders | Latex Resin (COVINAX FR- | 45.31 |
| | A 707) | |
| | Phenolic Resin (XB-90MO) | 8.94 |
| Coalescing agent | 2,2,4-Trimethyl-1,3- | 1.0 |
| | pentanediol monoisobutyrate | |
| | (Texanol) | |
| Thickener | Acrylic self-associative | 0.65 |
| | thickener (Thixol) | |

| | |
|---|---|
| TOTAL | 100.00 |

### Preparation of Exemplary Intumescent Composition Formulation According to Table 2.

The materials from Part I were charged to a vessel while mixing. The mixture was covered with plastic or wax paper and was allowed to stand for one hour for the mixture to reach equilibrium. The mixture was then gently mixed to form a suspension. The suspension was then ground using a Dispermat at 3500 rpm for 20 minutes. After the grinding was completed, the materials from Part II were then charged to the vessel while mixing. The pH and viscosity were then measured. If necessary, the pH was adjusted to above 8.5. The mixture was then thickened with Rheotech 3800 rheology improver to achieve the desired thickness.

TABLE 3

| | Parts Per |
|---|---|
| Ingredient | Hundred |

Part I

| | | |
|---|---|---|
| Water | Water | 19.8 |
| Dispersant | Polyether-modified styrene- | 0.84 |
| | maleic anhydride copolymer | |
| | (DISPERBYK-190) | |
| Pigment | Calcium Carbonate | 8.36 |
| Expandable graphite | Expandable graphite (<150 | 8.36 |
| | μm (1-5%), 150-300 μm (9- | |
| | 15%), 300-710 μm (79- | |
| | 85%) & >710 μm (1-5%) | |
| | (Nyagraph 251) | |
| | Expandable graphite (<45 | 8.36 |
| | μm (15-25%), 45-75 μm | |
| | (20-25%), 75-150 μm (35- | |
| | 50%), 150-180 μm (1-5%), | |
| | & >300 μm (0%) (Nyagraph | |
| | 35) | |
| Blowing agent | Melafine | 4.18 |
| Catalyst | Ammonium polyphosphate | 8.36 |
| | (Exolit AP 422) | |
| Defoamer | Emulsion of paraffin based | 0.21 |
| | mineral oils and hydrophobic | |
| | components, containing | |
| | silicone (BYK037) | |
| Thickener | Hydroxyethyl cellulose | 0.20 |
| | (Natrosol 250 HR, 2%) | |

Part II

| | | |
|---|---|---|
| Water | | 3.40 |
| Binders | Latex resin (Covinax 707) | 28.96 |
| | Phenolic resin (XB-91MO) | 7.27 |
| Coalescing agent | 2,2,4-Trimethyl-1,3- | 1.09 |
| | pentanediol-monoisobutyrate | |
| | (NX 795) | |
| Water softener | Sodium Polyphosphate, 10% | 0.63 |
| Thickener | Acrylic self-associative | 1.00 |
| | thickener (Thixol 53L) | |

| | |
|---|---|
| TOTAL | 100.00 |

### Exemplary Formulation for Intumescent Composition

### Preparation of Exemplary Intumescent Composition Formulation According to Table 3.

The materials from Part I were charged to a vessel while mixing. The mixture was covered with plastic or wax paper and was allowed to stand for one hour for the mixture to reach equilibrium. The mixture was then gently mixed to form a suspension. The suspension was then ground using a Dispermat at 3500 rpm for 20 minutes. After the grinding was completed, the materials from Part II were then charged to the vessel while mixing. The pH and viscosity were then measured. If necessary, the pH was adjusted to above 8.5. The mixture was then thickened with Rheotech 3800 rheology improver to achieve the desired thickness.

### Example 2—Bond Strength Evaluation of Laminates Comprising Intumescent Compositions

Initial testing was conducted on 2-ply laminates to measure the bond strength between the wood veneers, either comprising a mesh support coated with the intumescent composition as the intumescent layer, or using the liquid intumescent composition as an intumescent layer without the mesh support.

These tests were conducted in accordance with AS/NZS 4266.1:2017 section 8 “Tensile Strength perpendicular to the plane of the panel (Internal Bond Strength). The aim was to achieve a comparable or improved bond strength to that of a wood PVA glue in the absence of a mesh support.

To evaluate bond strength between the wood veneers a range of layered 2-ply “sandwiched” laminates were manufactured following the below procedures using different glue mixes and in some instance no glue mix or the intumescent composition itself, which acts as an adhesive.

2-Ply Pressing Conditions for Laminate with Mesh Support

Plywood with the mesh support was fabricated using the following conditions and utilised 40×40 cm and 2.7 mm thick Hoop Pine veneers with moisture content ranging from 4 to 6%.
1. 187.5 GSM of glue mix was coated onto each veneer totaling a glue spread 375 gsm in the laminate.
2. The mesh was sandwiched between veneers and left to set for an open assembly time of 4 minutes.
3. The laminate was then cold press 10 minutes at 120 psi.
4. The laminate was then left for a 10-minute closed assembly.
5. The laminate was then hot pressed for 4 minutes at 110° C. and 150 psi.
6. The laminate was then left to rest for a least 30 minutes prior to tensile strength measurement.

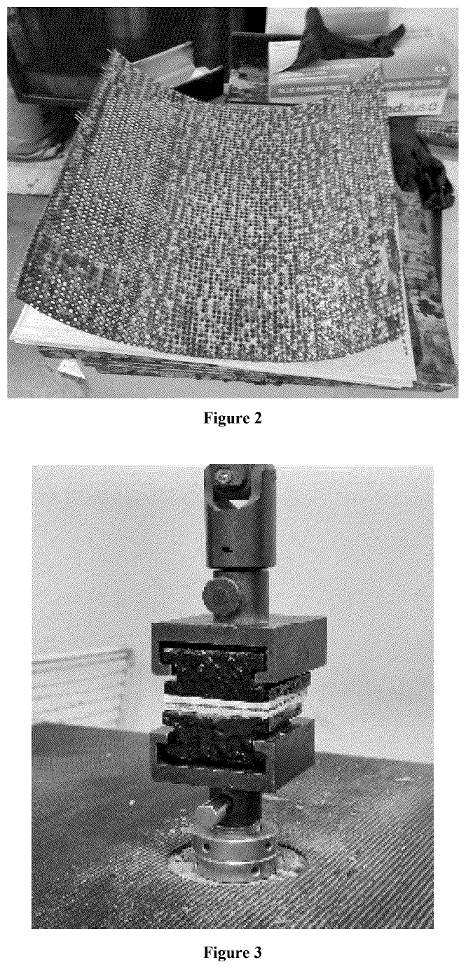

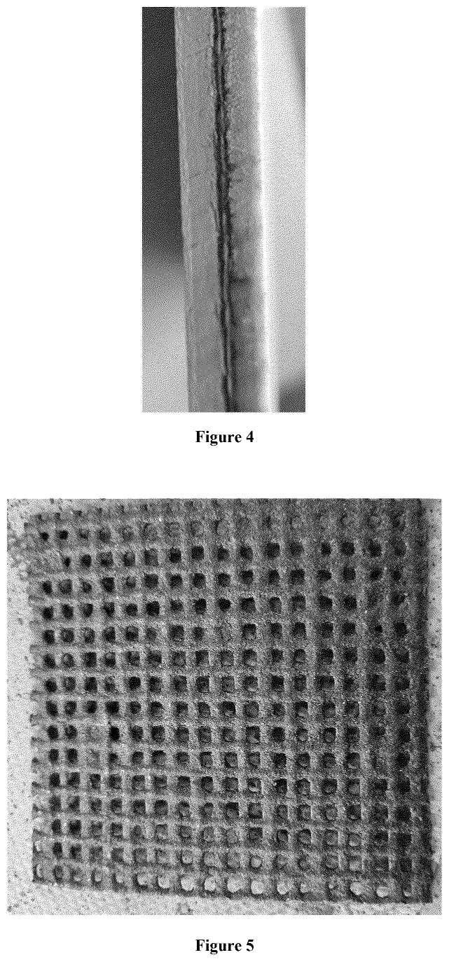

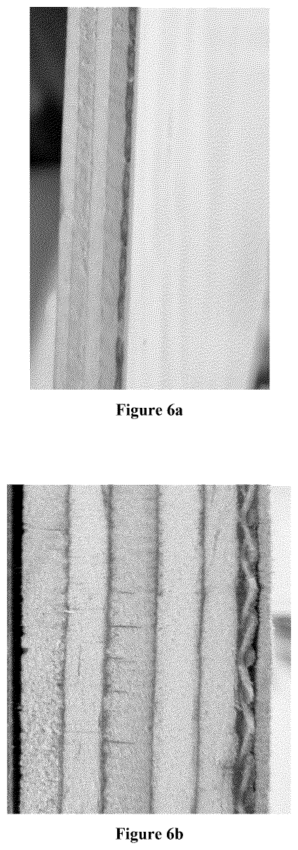

A representative example of the mesh used for bond strength testing sitting on top of a wood-based layer can be seen in FIG. 2. The press used to form the testing laminate comprising a mesh support as the intumescent layer used for the evaluation of “bond strength” can be seen in FIG. 3. An example of the corresponding veneer-mesh-veneer laminate used for bond strength testing is shown in FIG. 4.

2-Ply Manufacturing for Laminate with Liquid Intumescent Composition

Plywood without the mesh support was fabricated using the following conditions and utilised 40×40 cm and 2.7 mm thick Hoop Pine veneers with moisture content ranging from 4 to 6%.
1. 375 or 875 gsm of a liquid intumescent composition was coated onto a veneer and then another veneer was placed on top.
2. The laminate was left set for an open assembly time of 4 minutes.
3. The laminate was then cold pressed 10 minutes at 120 psi.
4. The laminate was then left for 24 hours at ambient temperature to full cure.
   2-Ply Manufacturing for Laminate with PVA Glue

Plywood comprising a PVA glue was fabricated using the following conditions and utilized 40×40 cm and 2.7 mm thick Hoop Pine veneers with moisture content ranging from 4 to 6%.
1. 375 gsm of a standard wood-based PVA was coated onto a veneer and then another veneer was placed on top.
2. The laminate was then cold pressed 30 minutes at 120 psi.
3. The laminate was then left for 24 hours at ambient temperature to full cure.

The bond strength of the two-ply laminates was then evaluated via internal bond (IB) testing, where a 50×50 mm square was pulled apart by 2±1 mm/min using a LLOYD LR10K. This recorded the maximum load sustained by the test piece in Newtons (N) before a failure point was reached, which allows for the Internal bond strength (Tensile Bond Strength) in N/mm to be calculated for each laminate.

### Preparation of Glue Mixes and Tensile Strength Values of Mesh Laminates

A range of phenolic-formaldehyde resin (PF) and melamine-urea-formaldehyde resins (MUF) were trialed for bonding the mesh support effectively between the veneer. The base components of these resins were largely phenol and formaldehyde for the phenolic-formaldehyde resin (resin utilised were Cascophen P6688W, P6625A & P6490) and melamine, urea and formaldehyde for the melamine-urea-formaldehyde resin (resins utilised were Cascomel M5888 & M1126) with some other small additives. The resins were then mixed to form a “glue mix” with different additives and fillers such as wheat flour, other wood-based flour such as modal or walnut or mineral components, in some instance other additives/hardeners such as ammonium chloride or boric acid were used.

Table 5 below lists the main glue mixes trialed with the mesh and their average tensile strength measured when breaking apart the veneer from the mesh system.

TABLE 5
Glue mixes trialled to adhere mesh to veneer backing and sacrificial
face veneer and tensile strengths of corresponding mesh-laminates.

| | MUF | MUF | MUF | MUF | PF | PF | PF | PF | |
|---|---|---|---|---|---|---|---|---|---|
| | Glue | Glue | Glue | Glue | Glue | Glue | Glue | Glue | |
| Glue | Mix 1 | Mix 2 | Mix 3 | Mix 4 | Mix 1 | Mix 2 | Mix 3 | Mix 4 | PVA |
| Resin | 72.0 | 58.8 | 58.8 | 68.1 | 69.1 | 71.9 | 75.4 | 58.8 | — |
| Wheat Flour | 18.5 | 17.6 | 12.7 | 15.7 | 10.2 | 3.9 | 8.2 | 17.6 | — |
| Modal Flour | — | — | — | — | — | 5.9 | — | — | — |
| Walnut | — | — | 5.0 | — | — | — | — | — | — |
| Flour | | | | | | | | | |
| Corn Cob | — | — | — | — | — | — | 8.2 | — | — |
| Residue | | | | | | | | | |
| J-Filler | — | 5.9 | 5.9 | — | 12.2 | 3.2 | — | 5.9 | — |
| NH₄Cl | — | — | — | 3.3 | — | — | — | — | — |
| MCAT955 | — | — | — | — | 2.7 | — | — | — | — |
| Caustic | — | — | — | — | — | 2.2 | — | — | — |
| Soda (46%) | | | | | | | | | |
| Water | 9.5 | 17.6 | 17.6 | 12.9 | 5.8 | 12.9 | 8.3 | 17.6 | — |
| PVA Glue | — | — | — | — | — | — | — | — | 100.0 |
| Sum | 100 | 100.0 | 100.0 | 100 | 100.0 | 100 | 100 | 100.0 | 100.0 |
| Mean IB | 0.17 | 0.26 | 0.26 | 0.42 | 0.14 | 0.28 | 0.19 | 0.17 | 0.14 |
| Strength | | | | | | | | | |
| (N/mm) | | | | | | | | | |

These experiments demonstrated that the mesh support with the intumescent composition can achieve a stronger tensile strength compared to what PVA wood glue achieves without the mesh present. Based on these data, the preferred adhesive for use with the mesh support is a melamine-urea-formaldehyde resin-based glue mix (Table 5-MUF glue mix 4-(M1126 resin)) as it provides the strongest tensile strength measured to date. However, both phenolic-formaldehyde resin and melamine-urea-formaldehyde resins provide examples of comparable or improved bond strength compared to what PVA wood glue achieves with the mesh support.

### Preparation of Glue Mixes and Tensile Strength Values of Non-Mesh Laminates

Further experiments were also conducted using various glue systems on laminates without mesh. The average IB strength of the tested glues are listed below in Table 6. These data show that, without the mesh support, the intumescent composition (acting itself as an adhesive) achieves better average tensile strength than the PVA glue when an equivalent material is used and is on par with the mesh system which utilised MUF glue mix 4, having a 0.44 and 0.42 N/mm average IB Strength, respectively. The intumescent composition applied by roller together (no adhesive), or the intumescent composition together with the M1126 resin (MUF glue mix 4), resulted in an IB score of ˜0.40 N/mm and performed better than standard PVA wood glue.

TABLE 6
Average IB Strength of tested glues using laminates with no mesh support.

| | | | | | | Mean IB |
|---|---|---|---|---|---|---|
| | Adhesive (no mesh | Test 1 | Test 2 | Test 3 | Test 4 | Strength |
| Panel | support) | (N/mm) | (N/mm) | (N/mm) | (N/mm) | (N/mm) |
| 1 | Standard Wood PVA | 0.17 | 0.49 | 0.28 | 0.46 | 0.36 |
| | glue (375 GSM) | | | | | |
| 2 | Standard Wood PVA | 0.38 | 0.24 | 0.37 | 0.49 | |
| | glue (375 GSM) | | | | | |
| 1 | ArmorBuilt liquid | 0.425 | 0.390 | 0.499 | 0.438 | 0.44 |
| | Applied by spray (375 | | | | | |
| | GSM) | | | | | |
| 1 | ArmorBuilt Liquid | 0.23 | 0.31 | 0.31 | 0.39 | 0.31 |
| | Applied by spray (875 | | | | | |
| | GSM) | | | | | |
| 1 | ArmorBuilt Liquid | 0.24 | 0.2 | 0.18 | 0.26 | 0.27 |
| | Applied by glue roller | | | | | |
| | (875 GSM) | | | | | |
| 2 | ArmorBuilt Liquid | 0.37 | 0.24 | 0.42 | 0.26 | |
| | Applied by glue roller | | | | | |
| | (875 GSM) | | | | | |

### MUF Optimization Experiments Using Mesh-Laminates.

Using the MUF glue mix 4 (which utilised Cascomel M1126 resin), further experiments were conducted to optimise the mesh-plywood manufacturing conditions with respect to hot-pressing temperature, pressure, and glue spread.

### Hot-Pressing Temperature Optimisation Using Mesh-Laminates

A range of temperatures were assessed for their corresponding influence on IB strength of the plywood. During the hot-pressing temperature optimisation, it was observed that at 110° C., a steam pocket formed in the center of the plywood, resulting in a poor IB strength (with an mean IB strength of 0.19 N/mm). Notably, reducing the water content of the glue mix by half did not rectify the issue. Therefore, decreasing the temperature at or below 100° C. was required to achieve a suitable IB strength of >0.4 N/mm, where 90° C. was found to be optimal in terms of IB strength. These data are listed below in Table 7.

TABLE 7
Hot-pressing temperature variation and corresponding
mean IB strength values.
Internal Bond Strength (N/mm)

| | | | | | Mean IB | Mean IB |
|---|---|---|---|---|---|---|
| Hot-pressing | Test | Test | Test | Test | Strength | Strength per |
| temperature | 1 | 2 | 3 | 4 | per panel | temperature |
| 110° C. | Fail | Fail | 0.39 | 0.03 | 0.11 | 0.19 |
| 110° C. | Fail | Fail | 0.22 | 0.26 | 0.12 | |
| 100° C. | 0.47 | 0.28 | 0.48 | 0.36 | 0.40 | 0.42 |
| 100° C. | 0.47 | 0.43 | 0.43 | 0.41 | 0.44 | |
| 90° C. | 0.37 | 0.41 | 0.38 | 0.43 | 0.40 | 0.45 |
| 90° C. | 0.54 | 0.42 | 0.46 | 0.60 | 0.50 | |
| 80° C. | 0.51 | 0.45 | 0.50 | 0.34 | 0.45 | 0.44 |
| 80° C. | 0.40 | 0.42 | 0.41 | 0.47 | 0.43 | |

### Hot-Pressing Pressure Optimisation Using Mesh-Laminates

Using the optimum temperature of 90° C., a range of pressures were assessed, including 150 psi, 285 psi and 425 psi. These data are presented below in Table 8. 150 psi was found to be optimal in terms of IB strength.

TABLE 8
Hot-pressing pressure variation and corresponding
mean IB strength values.
Internal Bond Strength (N/mm)

| | | | | | Mean IB | Mean IB |
|---|---|---|---|---|---|---|
| Hot-pressing | Test | Test | Test | Test | strength | Strength per |
| Pressure | 1 | 2 | 3 | 4 | per panel | Pressure |
| 425 psi | 0.32 | 0.28 | 0.31 | 0.20 | 0.28 | 0.29 |
| 425 psi | 0.24 | 0.43 | 0.31 | 0.20 | 0.30 | |
| 285 psi | 0.25 | 0.20 | 0.29 | 0.25 | 0.25 | 0.28 |
| 285 psi | 0.34 | 0.35 | 0.31 | 0.27 | 0.32 | |
| 150 psi | 0.17 | 0.38 | 0.44 | 0.34 | 0.33 | 0.37 |
| 150 psi | 0.41 | 0.34 | 0.36 | 0.50 | 0.40 | |

### Optimisation of Glue Mix Amount (Grams Per Square Meter (GSM)) Using Mesh-Laminates

Using the optimum temperature of 90° C. and optimum pressure of 150 psi, a range of glue mixes were assessed by varying the amount used in grams/M² (GSM), including 188 GSM, 280 GSM and 375 GSM. These data are presented below in Table 9. 280 GSM was found to be optimal in terms of IB strength, however, 375 GSM also provided suitable results.

TABLE 9
Glue mix (GSM) variation and corresponding
mean IB strength values.
Internal Bond Strength (N/mm)

| | | | | | Mean IB | Mean IB |
|---|---|---|---|---|---|---|
| | Test | Test | Test | Test | strength | Strength for |
| GSM | 1 | 2 | 3 | 4 | per panel | each GSM |
| 375 GSM | 0.47 | 0.41 | 0.37 | 0.42 | 0.42 | 0.40 |
| 375 GSM | 0.25 | 0.49 | 0.38 | 0.41 | 0.38 | |
| 280 GSM | 0.28 | 0.46 | 0.25 | 0.37 | 0.34 | 0.43 |
| 280 GSM | 0.51 | 0.40 | 0.54 | 0.66 | 0.53 | |
| 188 GSM | 0.17 | 0.38 | 0.44 | 0.34 | 0.33 | 0.37 |
| 188 GSM | 0.41 | 0.34 | 0.36 | 0.50 | 0.40 | |

### Example 3—Preparation of a Mesh Laminate

### Mesh Fabric Behind Face Veneer During Plywood Assembly

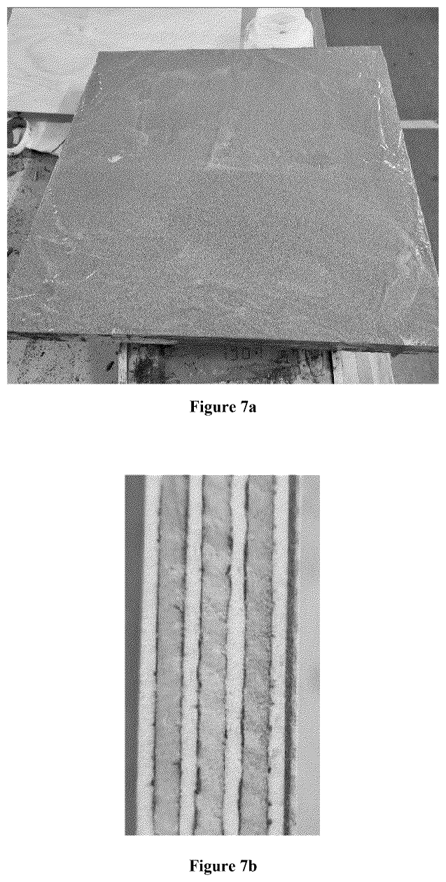

A typical method used to make the multilayered laminate comprising a mesh support during plywood assembly, is as follows:
1. Over a 10 min open assembly time (OAT), 375 gsm of MUF Glue mix 4 was spread on four 2.7 mm Hoop Pine veneers and layered up to make a 4-ply assembly with three glue lines.
2. Fiberglass mesh was coated by passing it through a dip tank of the liquid intumescent composition with application of the composition controlled via metering bars. The windows in the coated mesh were opened via air knife, and the coated sheet was dried either by hanging in ambient air or accelerated using forced hot air in a vertical drying tunnel (FIG. 5).
3. The mesh support was passed through a glue roller applying 375 gsm glue spread of MUF Glue mix 4 and placed on top of the 4 ply assembly within the 10 min OAT
4. An 0.5 to 1.5 mm face veneer was then placed on top of the mesh.
5. The 5-plywood assembly was then cold-pressed for 10 minutes at 120 psi.
6. This was then left for closed assembly time of 10 minutes.
7. The laminate was then hot-pressed at 90° C., 150 psi for 10 minutes.

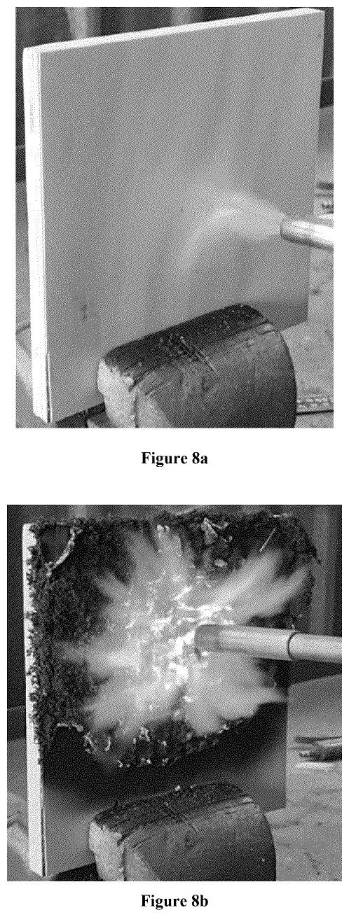

An example of the resulting mesh-laminate made using the above method is shown in FIGS. 6a and 6b.

### Mesh Fabric Behind Face Veneer on Wood Backing

A typical method used to make the multilayered laminate comprising a mesh support and pre-finished backing, is as follows:
1. Fiberglass mesh was coated by passing it through a dip tank of the liquid intumescent composition with application of the composition controlled via metering bars. The windows in the coated mesh were opened via air knife, and the coated sheet was dried either by hanging in ambient air or accelerated using forced hot air in a vertical drying tunnel.
2. The mesh support was passed through a glue roller applying 375 GSM glue spread of MUF Glue mix 4 and placed on top of the wood backing, followed by placement of a 0.5 to 1.5 mm face veneer on top of the mesh.
3. The assembly was cold-pressed for 10 minutes at 120 psi.
4. This was then left for closed assembly time of 10 minutes.
5. The laminate was then hot-pressed at 90° C., 150 psi for 10 minutes.

### Example 4—Preparation of Laminate (No Mesh)

Preparation of Exemplary Intumescent Layer with Intumescent Composition Coated on Internal Layer and Corresponding Non-Mesh Laminate.

A typical method used to make the multilayered laminate without the mesh support during plywood assembly, is as follows:

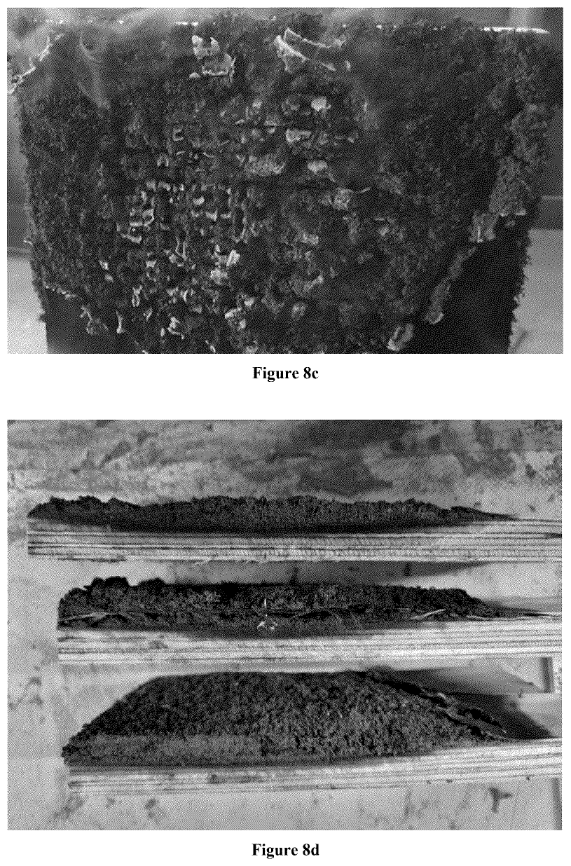

375 to 875 gsm of the intumescent formulation was coated onto a 40×40 cm plywood assembly by either spray coating, application via a paint roller, or glue roller (FIG. 7a). After coating the 40×40 cm plywood assembly with the intumescent composition, a 40×40 cm sacrificial veneer was then placed on top, and the panel was left to dry for an open assembly time ranging from 5 to 20 minutes, before being cold pressed to 100 to 300 psi for 10 to 120 minutes. The panel was then cured at ambient temperature for 24 hours. No other adhesive is required to adhere the material to the plywood. A typical example of an internal veneer coated with the intumescent composition and corresponding laminate is shown in FIG. 7b.

### Example 5—Fire Performance Testing of Multilayered Laminates

Laminates were prepared for testing as set out in Example 3-Mesh Fabric Behind Face Veneer on wood backing, and in Example 4-Preparation of Exemplary Intumescent Layer with Intumescent Composition Coated on Internal Layer and Corresponding Non-Mesh Laminate.

More specifically, an approximately 13 mm thick plywood panel backing made from Hoop pine veneers was either coated on one face with 875 GSM of the intumescent liquid or had a mesh support place on top which had been coated in 375 GSM of glue. A 0.8 mm Hoop pine face veneer was then placed on top and then the manufacturer conditions were followed as set out in the relevant section of Example 3, and Example 4, respectively.

### Blowtorch Experiments

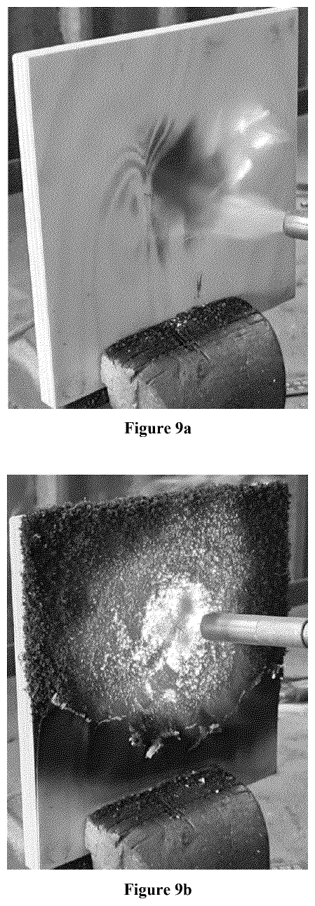

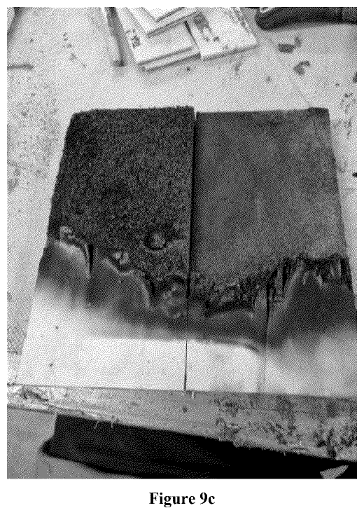

This test method was used to evaluate the fire-resistance characteristics of the mesh and non-mesh laminates when exposed to a blow-torch heat source. Two laminate examples (one comprising a mesh support, and one without) were directly subjected to a blowtorch flames (around 1250 to 2000° C.) for 5 minutes. Both examples withstood 5 minutes of direct torch and neither demonstrated signs of burn through the plywood. These experiments are shown in FIG. 8a-d and FIG. 9a-c. Accordingly, these images demonstrate that both the mesh and liquid intumescent-layered systems show excellent fire protection once the sacrificial layers are consumed by fire.

### Acoustic Burn Test

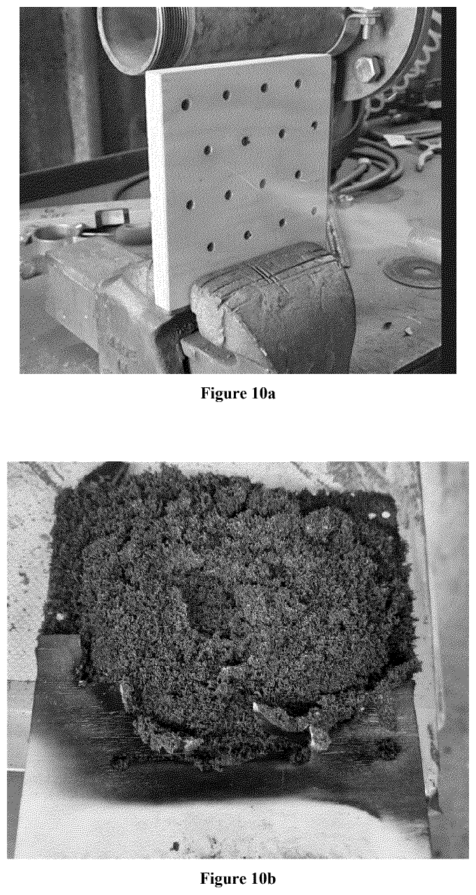

This test method was used to evaluate the fire-resistance characteristics of thermal/acoustic laminates when exposed to a blow-torch heat source. Acoustic holes were drilled into a piece of the multilayered laminate comprising a mesh support (roughly 35 mm from each center of hole and each hole is 8 mm). The laminate was burned with a blowtorch (around 1250 to 2000° C.) for 5 minutes. These experiments are shown in FIG. 10a-b. The acoustic laminates performed only slightly worse compared to the non-acoustic panel but effectively protect the plywood backing as the holes fill with intumescent material, thus stopping flame spread. The slightly worse performance is attributed to the air pressure of the blow torch pushing air through the holes when directly above, which moves the intumescent material (an unlikely air pressure in most fire scenarios). Accordingly, these data demonstrate that the multilayered laminate of the present disclosure may be used in settings that require both acoustic performance and fire performance.

### Cone Calorimeter Measurements

The fire performance of the multi-layered laminates was measured by cone calorimetry. Heat release rates (HRR) obtained using cone calorimeter measurements is one way of evaluating the ability of the intumescent material to stop/halt the spread of fire.

Using 100×100 mm multi-layered laminates, one comprising a mesh support and another comprising 875 gsm liquid intumescent composition, and both having an 0.8 mm Hoop pine sacrificial layer, cone calorimeter experiments were conducted using an ICone calorimeter from Fire testing Technologies with Servomex gas analyser.

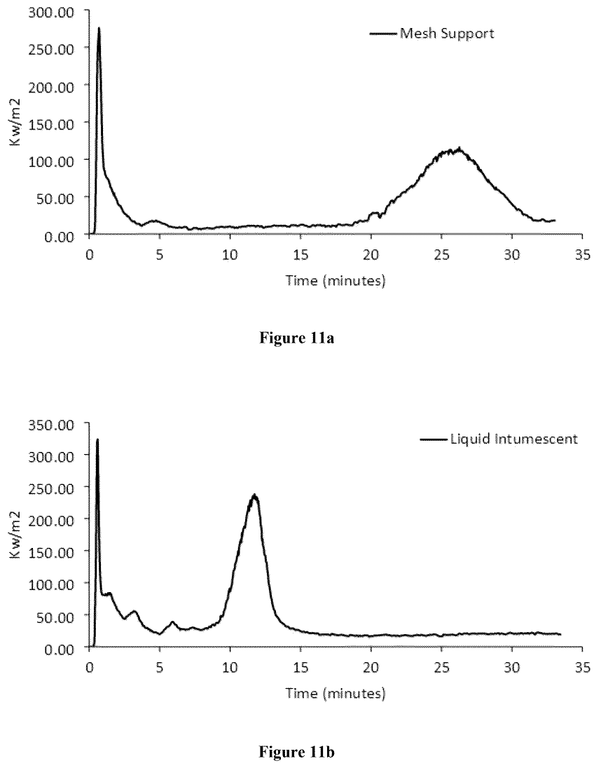

Graphs of time vs rate of heat release (kW/M²) are shown in FIGS. 11a-b. These data show that after the initial energy peak of the sacrificial layer burning off, an early and near zero energy plateau occurred, which was associated with the intumescing phase. For the mesh laminate, the plateau lasted for approximately 20 minutes, whereas for the laminate comprising the liquid-based intumescent layer, the energy plateau lasted for approximately 10 minutes.

1. A fire-resistant laminate comprising:
a wood or wood-based layer;
a sacrificial outer layer; and
an intumescent layer between the wood or wood-based layer and the sacrificial outer layer;
wherein the intumescent layer comprises an intumescent composition, the intumescent composition comprising:
an expandable graphite compound;
a binder comprising:
i) a thermoset compound; and
ii) a thermoplastic compound;
a catalyst; and
a blowing agent, and
wherein in use the sacrificial outer layer is consumable on contact with fire to expose the intumescent layer.

2. The fire-resistant laminate according to claim 1, wherein the expandable graphite compound has a mean particle size in the range of from 0.5 microns to 1000 microns.

3. The fire-resistant laminate according to claim 1, wherein the intumescent material comprises:
a first expandable graphite compound having a mean particle size in the range of from 50 microns to 250 microns, and
a second expandable graphite compound having a mean particle size in the range of from 150 micron to 350 microns.

4. The fire-resistant laminate according to claim 3, wherein the weight ratio of first expandable graphite compound to second expandable graphite compound is in the range of from 1:5 to 5:1, optionally from 1:4 to 4:1, or optionally about 1.5:3.5.

5. The fire-resistant laminate according to claim 2, wherein the intumescent material comprises:
a first expandable graphite compound having a mean particle size in the range of from 300 microns to 1000 microns, and
a second expandable graphite compound having a mean particle size in the range of from 0.5 micron to 250 microns.

6. The fire-resistant laminate according to claim 5, wherein the weight ratio of first expandable graphite compound to second expandable graphite compound is in the range of from 10:1 to 1:10, optionally from 4:1 to 1:4.

7. The fire-resistant laminate according to claim 1, wherein the expandable graphite compound is present in an amount in the range of from 1 weight percent to 30 weight percent, optionally from 5 weight percent to 25 weight percent, or optionally from 10 weight percent to 20 weight percent, based on the total weight of the intumescent composition.

8. The fire-resistant laminate according to claim 1, wherein the weight ratio of the thermoplastic compound to thermoset compound in the intumescent material is in the range of from 10:1 to 1:3, optionally from 8:1 to 1:3, or optionally from 6:1 to 1:2, or optionally from 5:1 to 1:1.

9. The fire-resistant laminate according to claim 8, wherein the binder is present in an amount in the range of from 10 weight percent to 80 weight percent, optionally from 25 weight percent to 75 weight percent, or optionally from 30 weight percent to 65 weight percent, based on the total weight of the intumescent composition.

10. The fire-resistant laminate according to claim 1, wherein the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, N-methylolacrylamide-vinyl acetate copolymer, and combinations thereof.

11. The fire-resistant laminate according to claim 10, wherein the thermoset compound comprises a phenol formaldehyde polymer and an N-methylolacrylamide-vinyl acetate copolymer.

12. The fire-resistant laminate according to claim 1, wherein the thermoplastic compound is selected from the group consisting of polyvinyl acetate, poly (methyl (meth) acrylate), poly (ethyl (methacrylate), poly (n-butyl (methacrylate), poly(isobutyl (meth) acrylate), poly (tert-butyl (meth) acrylate), poly (2-hydroxyethyl (meth) acrylate), poly (2-hydroxypropyl (methacrylate), poly (2-ethylhexyl (meth) acrylate), styrene acrylate, and combinations thereof.

13. The fire-resistant laminate according to claim 1, wherein the blowing agent is elected from the group consisting of melamine, plant melamine, melafine, urea, butyl urea, alumina trihydrate, dicyandiamide, benzene sulfonyl-hydrazide, azobisisobutyronitrile, 1,1-azobisformamide, 4,4′oxybis (benzenesulfonhydrazide), dinitroisopentamethylene tetraamine, calcium carbonate, titanium hydride, ammonium bicarbonate, sodium bicarbonate, sodium borohydrate, aluminum bicarbonate, potassium bicarbonate, guanidine, iron bicarbonate, sodium dodecyl sulfate, magnesium carbonate, magnesium carbonate hydroxide, ammonium polyphosphate (APP), melamine cyanurate, dimelamine phosphate, melamine pyrophosphate, melamine oxalate, melamine phthalate, and combinations thereof.

14. The fire-resistant laminate according to claim 1, wherein the blowing agent is present in a amount in the range of from 1 weight percent to 20 weight percent, optionally from 1 weight percent to 10 weight percent, or optionally from 1 to 5 weight percent, based on the total weight of the intumescent composition.

15. The fire-resistant laminate according to claim 1, wherein the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, hexamethylenetetramine, hexamine, ammonium polyphosphate, melamine cyanurate, dimelamine phosphate, methanesulfonic acid, and combinations thereof.

16. The fire-resistant laminate according to claim 1, wherein the catalyst is present in an amount in the range of from 0.5 weight percent to 20 weight percent, optionally from 1 weight percent to 10 weight percent, or optionally from 5 weight percent to 10 weight percent, based on the total weight of the intumescent composition.

17. The fire-resistant laminate according to claim 1, wherein the intumescent composition comprises one or more of a dispersant, defoamer, coalescing agent, thickener and pigment.

18. The fire-resistant laminate according to claim 17, wherein the intumescent composition comprises a dispersant, the dispersant comprising a high molecular weight block copolymer with pigment affinic groups and/or a modified styrene maleic acid copolymer.

19. The fire-resistant laminate according to claim 18, wherein the intumescent composition comprises a defoamer, the defoamer comprising an emulsion of paraffin-based mineral oils and hydrophobic particles containing silicon, and/or a modified organopolysiloxane emulsion.

20. The fire-resistant laminate according to claim 1, wherein the intumescent layer comprises a support which carries the intumescent composition.

21. The fire-resistant laminate according to claim 20, wherein the intumescent layer comprises a mesh support which is coated with the intumescent composition.

22. The fire-resistant laminate according to claim 21, wherein the mesh support is formed of activated carbon, graphite, fibreglass, wood, fibre, wire, or a combination thereof.

23. The fire-resistant laminate according to claim 1, wherein the intumescent layer is an intumescent composition which has been applied to the wood or wood-based layer and/or to the sacrificial layer.

24. The fire-resistant laminate according to claim 23, wherein the sacrificial layer and/or the wood or wood-based layer is formed of a material selected from the group consisting of laminated veneer lumber (LVL), low-density fibreboard (LDF), medium-density fibreboard (MDF), high-density fibreboard/hardboard (HDF), plywood, composite wood, marine plywood, multiply plywood, interior plywood, exterior plywood, fire-rated plywood, medium-density overlay plywood, high-density overlay plywood, low-density fibreboard, particle board, oriented strand board (OSB), parallel strand lumber (PSL), optimised engineered lumber (OEL), pine, solid lumber, strawboard, signboard, timber, construction timber, finishing timber, decorative timber, solid wood, hard wood, or a combination thereof.

25. The fire-resistant laminate according to claim 23, wherein the sacrificial layer and/or the wood or wood-based layer is formed of plywood or LVL.

26. The fire-resistant laminate according to claim 23, wherein the sacrificial outer layer has a thickness of up to 10 mm, optionally a thickness of up to 5 mm, or optionally a thickness of up to 3 mm, or optionally a thickness of up to 1 mm, or optionally a thickness of up to 0.5 mm.

27. The fire-resistant laminate according to claim 26, wherein the sacrificial outer layer is a face veneer or decorative panel.

28. The fire-resistant laminate according to claim 27, wherein one or more of the sacrificial outer layer, intumescent layer and wood or wood-based layer comprises an acoustic hole.

29. The fire-resistant laminate according to claim 28, wherein when the laminate is exposed to fire whilst measuring heat release using a cone calorimeter, following initial peak heat release associated with combustion of the outer sacrificial layer, a secondary peak heat release occurs more 5 minutes, optionally more than 10 minutes, or optionally more than 15 minutes, or optionally more than 20 minutes after the initial peak heat release.

30. The fire-resistant laminate according to claim 23, wherein two or more layers of the laminate are bonded together with an adhesive.

31. The fire-resistant laminate according to claim 30, wherein the intumescent composition comprises an adhesive, thereby enabling the intumescent composition to bond to the wood-or wood-based layer, and to bond to the sacrificial outer layer.

32. The fire-resistant laminate according to claim 31, wherein the intumescent layer comprises a support which carries the intumescent composition, and wherein the intumescent composition comprises an adhesive, thereby enabling the intumescent composition to bond to the support, and to bond the support to bond to the wood-or wood-based layer, and to the sacrificial outer layer.

33. The fire-resistant laminate according to claim 30, wherein the adhesive comprises an amino-formaldehyde resin, a phenolic-formaldehyde resin, a, melamine-urea-formaldehyde resin, a PVA glue, or a combination thereof.

34. The fire-resistant laminate according to claim 30, wherein the average tensile strength required to delaminate two or more of the layers of the laminate is in the range of from 0.38 to 0.50 N/mm, optionally in the range of from 0.40 to 0.48 N/mm, or optionally in the range of from 0.42 to 0.46 N/mm.

35. The fire-resistant laminate according to claim 1, wherein the laminate comprises:
one outer sacrificial layer;
one wood or wood-based layer; and
one intumescent layer which is disposed between the wood or wood-based layer and the outer sacrificial layer.

36. The fire-resistant laminate according to claim 1, wherein the laminate comprises:
two outer sacrificial layers on opposing faces of the laminate;
a wood or wood-based layer; and
two intumescent layers, one intumescent layer being disposed between the wood or wood-based layer and one outer sacrificial layer, and the other intumescent layer being disposed between the wood or wood-based later and the other outer sacrificial layer.

37. The fire-resistant laminate according to claim 35, wherein the laminate has one or more of the following: a fire rating of Group 1, Group 2, or Group 3 according to AS5637.1 or AS9705, and a fire rating of Group 1-s or Group 2-s according to NZBC.

38. A method of making the fire-resistant laminate, the method comprising the steps of:
coating a support with an intumescent composition as defined in claim 1; and
forming a fire-resistant laminate by bonding the coated support with a sacrificial outer layer and with a wood or wood-based layer;
or
coating a wood or wood-based layer with an intumescent composition as defined in claim 1 to form an intumescent layer; and
forming a fire-resistant laminate by bonding the intumescent layer and wood or wood-based layer to the sacrificial outer layer.

39. The method according to claim 38, the method comprises coating a support with an intumescent composition, and wherein the coated support is subsequently bonded with a sacrificial outer layer and with a wood or wood-based layer using an adhesive, optionally wherein the adhesive comprises a phenolic-formaldehyde resin, melamine-urea-formaldehyde resin, PVA glue, or a combination thereof.

40. The method according to claim 39, wherein the intumescent layer and wood or wood-based layer are bonded with the sacrificial outer layer using an adhesive, optionally wherein the adhesive comprises a phenolic-formaldehyde resin, melamine-urea-formaldehyde resin, PVA glue, or a combination thereof.

41. The method according to claim 38, wherein the laminate is cold pressed and/or hot-pressed, optionally using a pressure in the range of from 100 to 500 psi.

42. A fire-resistant article comprising the fire-resistant laminate according to claim 1.

43. The fire-resistant article of claim 42, wherein the article is a construction material, optionally wherein the article is a door, a wall, building panel, a skirting board, building facade, or an architrave.

44. The fire-resistant article of claim 43, wherein the article is a wall or door.

45. The fire-resistant laminate according to claim 36, wherein the laminate has one or more of the following: a fire rating of Group 1. Group 2, or Group 3 according to AS5637.1 or AS9705. and a fire rating of Group 1-s or Group 2-s according to NZBC.
